(19) United States
(12) Patent Application Publication
(10) Pub. No.: US 2026/0065379 A1
(43) Pub. Date: Mar. 5, 2026

(54) USING MACHINE LEARNING ALGORITHMS TO PREDICT TRANSACTIONS THAT MATCH EACH OTHER USING PATTERNS FROM MATCHING FEEDBACK

(71) Applicant: Oracle International Corporation, Redwood Shores, CA (US)

(72) Inventors: Toufic Wakim, Greenwich, CT (US); Abhishek Kumar, Altamonte Springs, FL (US); Pathanjali Malay, Leawood, KS (US); Tim Gaumont, Mesa, AZ (US)

(73) Assignee: Oracle International Corporation, Redwood Shores, CA (US)

(21) Appl. No.: 19/186,384

(22) Filed: Apr. 22, 2025

Related U.S. Application Data
(60) Provisional application No. 63/690,222, filed on Sep. 3, 2024.

(51) Int. Cl. G06Q 40/12; G06F 3/0482

(52) U.S. Cl. CPC G06Q 40/12; G06F 3/0482

(57) ABSTRACT

Systems, methods, and computer-readable media are provided for determining matches between records of different systems based on aggregate record data, and graphically marking potentially matched groups of data along with predicted confidence levels. Preliminary matching tools may allow allow users to define various rules based on which a majority of the transactions can be matched and reconciled. However, remaining transactions are disposed of in an interactive matching process. The matches may be determined unidirectionally from a source transaction to transactions from a target ledger, or bidirectionally from transactions in the target ledger to transactions other than the source transaction. Transactions may be matched many-to-many, one-to-many, or many-to-one, and a proposed order of match selections may be presented in a user interface. Match metadata or insights may be displayed to show a confidence of the match, reasons for the confidence, and/or a confidence of other matches that may be more beneficial than a match with a source transaction. The confidence and match insights may be generated by a machine learning model with access to transactions from a source transaction ledger and a target transaction ledger. The machine learning model may be trained on manual activity for prior matches that have been made. Matches may be performed using a hybrid machine learning model that accounts for random forests, decision trees, neural networks, naïve bayes algorithm, and/or a generalized linear model. Machine learning models also incorporate ongoing feedback from the users who can either accept or reject suggested matches and hence the models undergo an evolution process and constantly update from user patterns.

### BACKGROUND

Millions of transactions of all kinds are occurring daily on an intramural or extramural basis in large and small organizations, such as corporations, governments, schools, etc. These organizations may conduct transactions through various systems. Data from the transactions may be stored in various ways, such as in databases. Many times, the organization may desire to verify that transactions made and recorded in one system and are transferred to another system, either internal or external, can be tracked and matched. Data of any type can be matched from one system to another. For example, inventories of machine parts may be matched from one log of parts to another log of parts. As another example, money made at a point of sale may be matched against funds eventually deposited in a bank account. An organization may desire to trace sales transactions to bank deposits, so the organization desires to match bank deposits with sales transactions at one or more points of sale. That is to say that the organization may desire to align a sales transaction with a bank transaction. Tracking such transaction alignment by conventional accounting software may present limitations and inefficiencies. Misalignments may be often missed, simply due to overwhelming effort needed to search for them. In these situations, organizations may be forced to write off misaligned transactions such as missing or unaccountable bank deposits that do not correspond to sales data. Many organizations may write off millions of dollars a year due to lost or unaccountable revenue. Because of such financial consequences of transaction misalignments, new software solutions are sought to reduce search efforts to verify that transactions occurring in one system align with transactions occurring in another system.

### BRIEF SUMMARY

Systems, methods, and computer-readable media are provided for determining matches between records of different systems based on aggregate record data, and graphically marking potentially matched groups of data along with predicted confidence levels. Preliminary matching tools may allow users to define various rules based on which a majority of the transactions can be matched and reconciled. However, remaining transactions are disposed of in an interactive matching process. The matches may be determined unidirectionally from a source transaction to transactions from a target ledger, or bidirectionally from transactions in the target ledger to transactions other than the source transaction. Transactions may be matched many-to-many, one-to-many, or many-to-one, and a proposed order of match selections may be presented in a user interface. Match metadata or insights may be displayed to show a confidence of the match, reasons for the confidence, and/or a confidence of other matches that may be more beneficial than a match with a source transaction. The confidence and match insights may be generated by a machine learning model with access to transactions from a source transaction ledger and a target transaction ledger. The machine learning model may be trained on manual activity for prior matches that have been made. Matches may be performed using a hybrid machine learning model that accounts for random forests, decision trees, neural networks, naïve bayes algorithm, and/or a generalized linear model. Machine learning models also incorporate ongoing feedback from the users who can either accept or reject suggested matches and hence the models undergo an evolution process and constantly update from user patterns.

In some embodiments, a computer-implemented method includes causing display of at least part of a first table of data and at least part of a second table of data. The at least part of the first table is displayed for matching against the second table. The first table of data may include point of sales transactions, for example. The second table of data may include bank deposit transactions, for example.

In some embodiments, the computer-implemented method further includes combining a first plurality of values of a first record of the first table and generating a first vector embedding of the first plurality of values as combined. For example, a plurality of values associated with a sales transaction, such as a store identifier, amount spent, whether the transaction was a cash or credit card transaction, may be concatenated together into a contiguous string.

In some embodiments, the computer-implemented method further includes combining a second plurality of values of one or more second records of a plurality of second records of the second table into one or more combined sets of values, and generating one or more second vector embeddings of the one or more combined sets of values. The second plurality of values satisfy one or more conditions. For example, a value from the second record of the second table by itself can equal a value from the first record of the first table, or be within a predefined threshold of the first value. A value from the second record of the second table can also be combined with one or more other values from one or more other second records in the second table, whose sum is equal to the first value, or is within a predetermined threshold thereof.

In some embodiments, the computer-implemented method further includes determining a distance between a first vector embedding and particular one or more second vector embeddings. At least a first set of one or more second records has a closer distance than at least a second set of one or more second records. Determining the distance uses a trained machine learning model that applies different weights for different component-level differences of a plurality of component-level differences from the first plurality of values.

The particular one or more second vector embeddings may be taken from a plurality of generated second vector embeddings. For example, for a record of a table, the data in each column within a record may be concatenated to a contiguous string and stored as a vector, where each component of the vector is a natural language word value, an alphanumerical value, or a numerical value within the contiguous string. Embedding may include the concatenation of all values in columns in the first and second tables that are associated with a transaction. The first vector embedding result is a contiguous string. The components of the concatenated string may also be tokens representing the actual values.

In some embodiments, the computer-implemented further method includes graphically marking a first set of one or more second records with a higher confidence than a second set of one or more second records. The graphical marking may include color-coded displays of one or more matched values displayed in the second table of a graphical user interface, where the color coding represents confidence levels of the value match to particular values in the first table. Thus, multiple values of the second table may be matched to one particular value of the first table, where the cells in a spreadsheet containing the second table values may be colored according to a color scale, where each color of the scale indicates a confidence level (e.g., 95%, 90%, 80%, 50%, etc.) for value matches.

In some embodiments, the computer-implement method further includes causing a display of an option to select the first set or the second set as a match for the first record.

Using the option causes the selected set to be stored in association with the first record. The selected set may be stored in a location accessible to the user interface such that the user may easily retrieve the selected set of second records to make comparisons to the first record in the first table.

In a further embodiment, the computer-implemented method includes causing display of a first table of data and a second table of data. The first table is displayed for matching against the second table. The computer-implemented method further includes, for a first record of the first table, combining a first plurality of values of the first record, and generating a first vector embedding of the first plurality of values as combined. The computer-implemented method further includes, for each set of one or more second records of a plurality of second records of the second table that satisfy one or more conditions (e.g., a value that could sum up with zero or more other records of the second table to be the same or within a threshold amount of a value of the first record), combining a second plurality of values of the one or more second records into one or more combined sets of values, and generating one or more second vector embeddings of the one or more combined sets of values. The computer-implemented method further includes, for each particular one or more second vector embeddings of a plurality of second vector embeddings generated from the generating the one or more second vector embeddings, determining a distance between the first vector embedding and the particular one or more second vector embeddings. At least a first set of one or more second records has a closer distance than at least a second set of one or more second records. Determining the distance uses a trained machine learning model that applies different weights for different component-level differences of a plurality of component-level differences from the first plurality of values. The computer-implemented method further includes, based at least in part on determining the distance, graphically marking the first set of one or more second records with a higher confidence than the second set of one or more second records. The computer-implemented method further includes causing display of an option to select the first set or the second set as a match for the first record. Using the option causes the selected set to be stored in association with the first record. The one or more conditions check whether a value of the set of one or more second records when aggregated with zero or more other records of the set of one or more second records to be the same or within a threshold amount of a corresponding value of the first record.

In a further embodiment, the computer-implemented method includes causing display of a first table of data and a second table of data. The first table is displayed for matching against the second table. The computer-implemented method further includes, for a first record of the first table, combining a first plurality of values of the first record, and generating a first vector embedding of the first plurality of values as combined. The computer-implemented method further includes, for each set of one or more second records of a plurality of second records of the second table that satisfy one or more conditions (e.g., a value that could sum up with zero or more other records of the second table to be the same or within a threshold amount of a value of the first record), combining a second plurality of values of the one or more second records into one or more combined sets of values, and generating one or more second vector embeddings of the one or more combined sets of values. The computer-implemented method further includes, for each particular one or more second vector embeddings of a plurality of second vector embeddings generated from the generating the one or more second vector embeddings, determining a distance between the first vector embedding and the particular one or more second vector embeddings. At least a first set of one or more second records has a closer distance than at least a second set of one or more second records. Determining the distance uses a trained machine learning model that applies different weights for different component-level differences of a plurality of component-level differences from the first plurality of values. Based at least in part on determining the distance, the computer-implemented method further includes graphically marking the first set of one or more second records with a higher confidence than the second set of one or more second records. The computer-implemented method further includes causing display of an option to select the first set or the second set as a match for the first record. Using the option causes the selected set to be stored in association with the first record. The corresponding value of the first record is a transaction amount.

In a further embodiment, the computer-implemented method includes causing display of a first table of data and a second table of data. The first table is displayed for matching against the second table. The computer-implemented method further includes, for a first record of the first table, combining a first plurality of values of the first record, and generating a first vector embedding of the first plurality of values as combined. The computer-implemented method further includes, for each set of one or more second records of a plurality of second records of the second table that satisfy one or more conditions (e.g., a value that could sum up with zero or more other records of the second table to be the same or within a threshold amount of a value of the first record), combining a second plurality of values of the one or more second records into one or more combined sets of values, and generating one or more second vector embeddings of the one or more combined sets of values. The computer-implemented method further includes, for each particular one or more second vector embeddings of a plurality of second vector embeddings generated from the generating the one or more second vector embeddings, determining a distance between the first vector embedding and the particular one or more second vector embeddings. At least a first set of one or more second records has a closer distance than at least a second set of one or more second records. Determining the distance uses a trained machine learning model that applies different weights for different component-level differences of a plurality of component-level differences from the first plurality of values. The computer-implemented method further includes, based at least in part on determining the distance, graphically marking the first set of one or more second records with a higher confidence than the second set of one or more second records. The computer-implemented method further includes causing display of an option to select the first set or the second set as a match for the first record. Using the option causes the selected set to be stored in association with the first record. Determining the distance comprises determining a cosine distance between the first vector embedding and the one or more second vector embeddings.

In a further embodiment, the computer-implemented method includes causing display of a first table of data and a second table of data. The first table is displayed for matching against the second table. The computer-implemented method further comprises, for a first record of the first table, combining a first plurality of values of the first record, and generating a first vector embedding of the first plurality of values as combined. The computer-implemented method further comprises, for each set of one or more second records of a plurality of second records of the second table that satisfy one or more conditions (e.g., a value that could sum up with zero or more other records of the second table to be the same or within a threshold amount of a value of the first record), combining a second plurality of values of the one or more second records into one or more combined sets of values, and generating one or more second vector embeddings of the one or more combined sets of values. The computer-implemented method further comprises, for each particular one or more second vector embeddings of a plurality of second vector embeddings generated from the generating the one or more second vector embeddings, determining a distance between the first vector embedding and the particular one or more second vector embeddings. At least a first set of one or more second records has a closer distance than at least a second set of one or more second records. Determining the distance uses a trained machine learning model that applies different weights for different component-level differences of a plurality of component-level differences from the first plurality of values. The computer-implemented method further comprises, based at least in part on determining the distance, graphically marking the first set of one or more second records with a higher confidence than the second set of one or more second records. The computer-implemented method further comprises causing display of an option to select the first set or the second set as a match for the first record. Using the option causes the selected set to be stored in association with the first record, further comprising causing display of another option to select another of the first set or the second set as a non-match for the first record. Using the other option causes the other selected value to be provided as negative feedback to a trained machine learning model. The trained machine learning model updates one or more of the weights based at least in part on the negative feedback.

The trained machine learning model may be updated based on user selection feedback where the user selection feedback is treated as a labeled pair of positive feedback to the trained machine learning model, with a selected matched set and a source record being provided as the labeled pair. The trained machine learning model may then be updated to make predictions using the labeled pair as part of the training data for further tuning or training or other updating.

In a further embodiment, the computer-implemented method includes causing display of a first table of data and a second table of data. The first table is displayed for matching against the second table. The computer-implemented method further includes, for a first record of the first table, combining a first plurality of values of the first record, and generating a first vector embedding of the first plurality of values as combined. The computer-implemented method further includes, for each set of one or more second records of a plurality of second records of the second table that satisfy one or more conditions (e.g., a value that could sum up with zero or more other records of the second table to be the same or within a threshold amount of a value of the first record), combining a second plurality of values of the one or more second records into one or more combined sets of values, and generating one or more second vector embeddings of the one or more combined sets of values. The computer-implemented method further includes, for each particular one or more second vector embeddings of a plurality of second vector embeddings generated from the generating the one or more second vector embeddings, determining a distance between the first vector embedding and the particular one or more second vector embeddings. At least a first set of one or more second records has a closer distance than at least a second set of one or more second records. Determining the distance uses a trained machine learning model that applies different weights for different component-level differences of a plurality of component-level differences from the first plurality of values. The computer-implemented method further includes, based at least in part on determining the distance, graphically marking the first set of one or more second records with a higher confidence than the second set of one or more second records. The computer-implemented method further includes causing display of an option to select the first set or the second set as a match for the first record. Using the option causes the selected set to be stored in association with the first record. Using the option causes the trained machine learning model to update one or more of the weights based at least in part on positive feedback for the selected set.

In a further embodiment, the computer-implemented method includes causing display of a first table of data and a second table of data. The first table is displayed for matching against the second table. The computer-implemented method further includes, for a first record of the first table, combining a first plurality of values of the first record, and generating a first vector embedding of the first plurality of values as combined. The computer-implemented method further includes, for each set of one or more second records of a plurality of second records of the second table that satisfy one or more conditions (e.g., a value that could sum up with zero or more other records of the second table to be the same or within a threshold amount of a value of the first record), combining a second plurality of values of the one or more second records into one or more combined sets of values, and generating one or more second vector embeddings of the one or more combined sets of values. The computer-implemented method further includes, for each particular one or more second vector embeddings of a plurality of second vector embeddings generated from the generating the one or more second vector embeddings, determining a distance between the first vector embedding and the particular one or more second vector embeddings. At least a first set of one or more second records has a closer distance than at least a second set of one or more second records. Determining the distance uses a trained machine learning model that applies different weights for different component-level differences of a plurality of component-level differences from the first plurality of values. The computer-implemented method further includes, based at least in part on determining the distance, graphically marking the first set of one or more second records with a higher confidence than the second set of one or more second records. The computer-implemented method further includes causing display of an option to select the first set or the second set as a match for the first record. Using the option causes the selected set to be stored in association with the first record. Determining the distance between the first vector embedding and the particular one or more second vector embeddings comprises determining a first distance between the first vector embedding and a third vector embedding and determining a second distance between the first vector embedding and a fourth vector embedding, and aggregating the first distance and the second distance to generate the distance.

In various aspects, a system is provided that includes one or more data processors and a non-transitory computer-readable storage medium containing instructions which, when executed on the one or more data processors, cause the one or more data processors to perform part or all of one or more methods disclosed herein.

In various aspects, a computer-program product is provided that is tangibly embodied in a non-transitory machine-readable storage medium and that includes instructions configured to cause one or more data processors to perform part or all of one or more methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 is a process flow chart implemented by the data management system, in accordance with certain aspects.

FIG. 2A illustrates a point-of-sales ledger table from a first embodiment of an exemplary user interface (UI) for displaying sales and banking transactions and ranked matches for a query related to one of the sales transactions, in accordance with certain aspects.

FIG. 2B illustrates a process ledger table from the first embodiment of the exemplary UI from FIG. 2A.

FIG. 2C shows a dual display by the user interface of both the point-of-sale ledger table and the processor ledger table for ease of viewing.

FIG. 2D shows an interface region that that may be displayed by the user interface, optionally overlaying the point-of-sale ledger table, suggesting relative advantages and relative disadvantages of choosing a match for a selected one or more point-of-sale transactions or one or more other suggested point-of-sale transactions.

FIG. 2E shows a dual display of the point-of-sale ledger table in FIG. 2D and processor ledger table in a side-by-side manner as this view is presented by the UI to the user.

FIGS. 3A and 3B show enlarged views of ledger tables where rows are highlighted with color-coded highlights to show closest match confidence levels to a query, in accordance with certain aspects.

FIG. 4A shows a portion of a user interface, whereby a match selection feature of the user interface is opened by the user, in accordance with certain aspects.

FIG. 4B shows a portion of the user interface where check boxes in a display preference feature are both checked by the user in an alternative option prompting the display of all rows having close matches to the query, in accordance with certain aspects.

FIG. 5A illustrates a point-of-sales ledger table of a second embodiment of an exemplary user interface (UI) for displaying sales and banking transactions and ranked matches for a query related to one of the sales transactions, in accordance with certain aspects.

FIG. 5B illustrates a processor ledger table of the second embodiment of the exemplary UI from FIG. 5A.

FIGS. 6A-6B show example interface regions that may be generated for the UI in response to choices of point-of-sales transactions made and ensuing predicted matches, where the example interface regions show metadata to the user to bring attention to attributes of the predicted matches that may impact the user's decision to match a point-of-sale transaction.

FIG. 6C shows an additional or alternative example interface region that may be generated by the UI to provide insights on multiple predicted matches for a point-of-sale transaction in order to guide the user in selecting match choices for the point-of-sale transaction.

FIG. 7 illustrates a block diagram for a data management system in accordance with certain aspects.

FIG. 8 depicts a simplified diagram of a distributed system for implementing an embodiment of the transaction reconciliation management system, in accordance with certain aspects.

FIG. 9 is a simplified block diagram of one or more components of a system environment by which services provided by one or more components of an embodiment system may be offered as cloud services, in accordance with certain aspects.

FIG. 10 illustrates an example computer system that may be used to implement certain aspects.

### DETAILED DESCRIPTION

Computer-implemented techniques are provided herein for a data management system to determine matches between transactions in different systems within an organization. The data management system provides an interface to support searching for matches between transactions such as, for example, a purchase at a point of sale and ledger items entered on a ledger sheet, or bank deposits. The data management system compares tokenized string data from a database where transaction data may be concatenated together as strings. The concatenated data are associated with a particular transaction. The data management system searches for closest matches by similarities between strings in a first transaction database with strings in an accounting ledger database, for example. The accounting ledger may contain bank deposit records, for example. In some embodiments, a user can activate a button on a user interface that color codes matched items by confidence ranking, where the color code can represent a confidence level of the match. The confidence ranking may be based on determination of vector distances between strings, such as a Pearson Correlation, Euclidean Distance, Manhattan distance, Minkowski distance, Hamming distance, Chebyshev distance, Jaccard distance, Haversine distance, Sorensen-Dice distance or Levenshtein distance.

A description of the data management system is provided in the following sections:
TRANSACTION RECONCILIATION
TRANSACTION RECONCILIATION INTERFACE EXAMPLES
HYBRID MODELS FOR MATCHING
DATA MANAGEMENT SYSTEM
COMPUTER SYSTEM ARCHITECTURE The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

### TRANSACTION RECONCILIATION

Transaction reconciliation is supported by a trained machine learning model or content classifier that is trained to create vector embeddings for content from different data sets and search for matches between the content that have occurred. An example is reconciliation of a sales transaction record in a point of sales system and bank deposit records in a ledger system that keeps records of bank deposits for an organization. An organization desires to track one or more sales transactions from one system to another. The systems may be internal or external to the organization. For the latter, the external system has a relationship with the organization. For example, the external system is a bank with which a corporation such as a store chain does its banking, whereas the internal system is an outlet or a store that can be generalized as a point-of-sale location.

The transaction reconciliation process may use distance measurements to rank the level of confidence of the match between content vector embeddings, where the distance measurement is obtained by a semantic search supported the machine learning model or content classifier. The transaction may be a sales transaction at a point of sale, such as at a particular store outlet. The sale is then recorded into a ledger database. Metadata can be associated with the sale record. For example, sale amount, store location, date, time, payment type (cash or credit), are amongst the metadata that can be associated with the sale. As such, the metadata is represented as string values and numerical values that occur along a record in the database, occupying different columns. The transaction reconciliation process may then search for and identify relevant fields (e.g., that are visible to the user as columnar data (within a record) in both the point of sales table and deposit ledger table) that could be identical to each other, concatenate those fields on both sides into a contiguous string and embed the concatenated string.

An example is a point-of-sale transaction that has been tracked to a particular bank deposit. A semantic search may be performed on every bank deposit record by the transaction reconciliation process to find the nearest matches to the sale or source record. The transaction reconciliation process may identify one or more potential bank records that correspond to the sale. However, for some identifying data, such as an authorization code, the monetary amounts or dates/times are not identical. The transaction reconciliation process may find the closest matches, for example, including matches within a threshold distance from the source record. The transaction reconciliation process may perform a semantic search by creating content vector embeddings of the source record and various potentially matching target records or sets of target records. The content vector embeddings may be compared, for example, based on cosine similarity between the embeddings, to determine which embeddings of target records are the closest matches for embeddings of source records. The closest matches may be presented on a user interface. For example, each of three identified bank deposits may be presented in a ledger format to the user, with rows colored to indicate the confidence level of the match.

The semantic search function replaces the need for a user to input search rules, such as finding the transactions having the closest dates, or monetary amounts. The transaction reconciliation process may search for two or more bank deposits whose amounts sum to the sales amount, in addition to singular bank deposits that match the amount exactly or within a threshold.

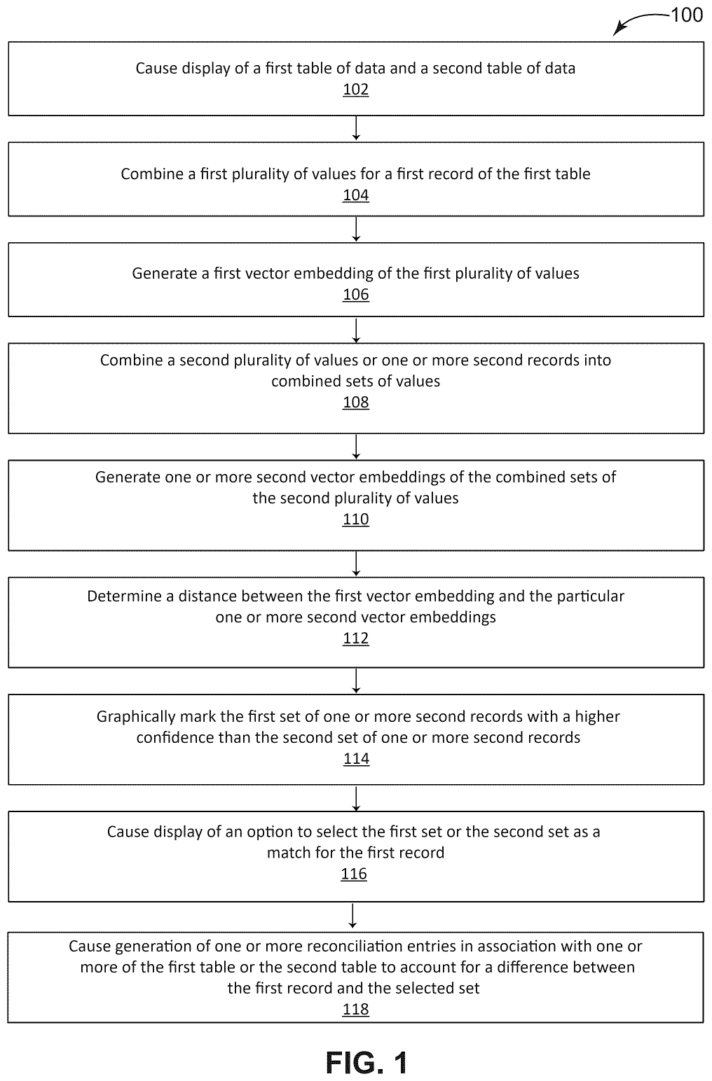

FIG. 1 illustrates a flow chart showing an example process flow 100 for the data management system. FIG. 1 starts at block 102, where two databases are displayed in tabular format in the user interface. Thus, the databases are presented in the user interface as two tables. A first table may be a point-of-sale ledger from a particular point of sale, such as a store outlet. A second table may be a bank deposit ledger for a bank used by the organization managing the store. The second table contains bank deposit data in a ledger format. A user may input a query to the user interface, such as by highlighting a particular sale transaction, asking the data management system to perform a search for a bank deposit that is associated with the sale transaction. The first table contains metadata associated with the sale transactions, such as store location (e.g., store identifier), amount, payment type, date/time, authorization code, and other data. These metadata are captured as fields within a record of the first table, where each field occupies a column in the first table in the user interface.

The second table contains bank deposit amounts, along with associated metadata. The metadata associated with each bank deposit amount may be the same metadata presented in the first table for corresponding sales. The bank record metadata may also occupy columns showing fields within a corresponding record containing the bank deposit amount.

At block 104, the data management system combines the field data from one or more records in the first table representing point-of-sales data. Here, a user may select one or more records in the point-of-sales ledger. Selected records in the first table correspond to particular sales transactions. Metadata values stored in the various fields within the selected records may be concatenated together to produce one or more complex strings, where each complex string corresponds to selected records in the first table.

At block 106, a trained machine learning model embeds the one or more concatenated strings into vectors whose components represent the fields in the selected records of the first table. The concatenated strings are associated with particular sales records, and contain the metadata associated with the selected sales. The vectors containing the sales data may be measured against metadata of all bank ledger records to search for matches.

The user's query may be input automatically to the machine learning model upon selection of records within the first table (e.g., sales ledger). At block 108, the data management system may combine bank deposit metadata associated with records corresponding to some or all bank deposits made within a predetermined period around one or more particular sales transactions, or meeting other criteria. The metadata from each record containing a bank deposit amount are combined into a set of complex strings by concatenation of the fields within each record of the second table.

At block 110, the machine learning model performs vector embeddings of each complex string of the plurality of complex strings from the records in the second table, created in block 108.

At block 112 the machine learning model searches the second table (e.g., bank deposit ledger) for matches based on a semantic search, optionally using a variety of algorithms and optionally weighing different components of the vector embeddings differently based on feedback about prior matches. Similarities between metadata in a vector containing embedded metadata from the first table and metadata in a vector containing embedded metadata from the second table may be determined by measurement of distances between some or all components in the two vectors, optionally accounting for the component-specific weights. The distance metric may be associated with a number of characters in a string that are dissimilar, for example, or numerical differences of numerical data.

An example of an algorithm employed for measurement of distance between vectors is cosine similarity, where a dot product of two vectors, optionally after normalization and/or component-specific weights been applied, may determine a cosine relationship between the two vectors. The cosine similarity is calculated for the angle between the two vectors. For example, a cosine value near one indicates a large degree of similarity, where the two vectors point substantially in the same direction, and a value near zero indicates a high degree of dissimilarity, where the two vectors point in very different directions. Other similarity measurement algorithms that measure distances between vectors may be employed. Other distance measuring algorithms beside cosine similarity may be employed by the data management system in comparing vector embeddings. For example, the data management system may employ an algorithm capable of performing any of a Pearson Correlation, Euclidean Distance, Manhattan distance, Minkowski distance, Hamming distance, Chebyshev distance, Jaccard distance, Haversine distance, Sorensen-Dice distance or Levenshtein distance.

In various embodiments, the data management system or machine learning model may apply different weights for different component level differences between vector embeddings when determining the components or the distances between components using one or more of the algorithms listed above. In various embodiments, distances may be determined for sets of vector pairs and aggregated. For example, distances between a first vector containing embedded sales transaction metadata and second and third vectors containing embedded metadata from two separate deposit transactions may be aggregated to generate an aggregated distance.

At block 114, matches may be found among the plurality of vectors that were analyzed by the data management system. The matches may or not be exact matches. That is, for example, if similarity measurements performed between vectors find perfect matches, then all metadata from records both first and second tables are aligned. If perfect matches were not found, then the data management system ranks the closest matches according to statistical confidence levels. Closest matches may be selected by the data management system if they surpass a threshold statistical confidence level based on the measured distances. The confidence levels (e.g., 95%, 80%, 50%, etc.) may be inversely related to the measured distances between components of a first vector (derived from the first table) and a second vector (derived from the second table).

At block 116, the data management system may highlight records in the second table of the user interface with a coded background color scheme. Perfect or close matches are presented to the user as highlighted records having colors indicating the confidence level of the match. The matches may have differences in some of the metadata, but have same or very close sales and deposit amounts. These banking transactions may be ranked with a high confidence of match and displayed to the user as record highlights (in the second table) of a certain color. In other instances, no match between monetary values among deposit transactions recorded in the banking ledger is found for a particular sales transaction. The data management system may find some deposit amounts that when combined may sum to exactly or approximately the sales amount. These banking transactions may be highlighted and presented to the user, but ranked with a lower confidence level, thus highlighted with a different color than the higher-ranked matches. An example of confidence level display in the user interface is given below.

At block 118, the data management system may cause generation of one or more reconciliation entries in association with one or more of the first table or the second table to account for a difference between the first record and the selected set. The generation of the reconciliation entr(ies) may select a ledger that is most frequently selected for reconciliation against in similar scenarios, for example, using a machine learning model to determine which ledger should be reconciled against and which ledger should serve as the source of truth in the given scenario. The machine learning model may account for similar scenarios when differences have been detected between ledgers where journal entries or other reconciliation entries were created to reconcile the differences.

In some embodiments, an option may be included in the user interface to select some matches in the displayed closest matches as a non-match. This option may provide a negative feedback for deterring the machine learning model from including some transactions as matches to the query. For example, use of this option may train the machine learning model to refine its search to exclude some transactions according to certain user-defined or user-determined criteria. These criteria may be based on factors other than transaction amount and authorization codes, for example. The machine learning model can then update weights for matching scores (e.g., based on distance determinations) based on consideration of the user criteria. Similarly, UI options may provide positive feedback to the machine learning model to encourage transactions having other attributes that are in line with accepted matches.

### TRANSACTION RECONCILIATION INTERFACE EXAMPLES

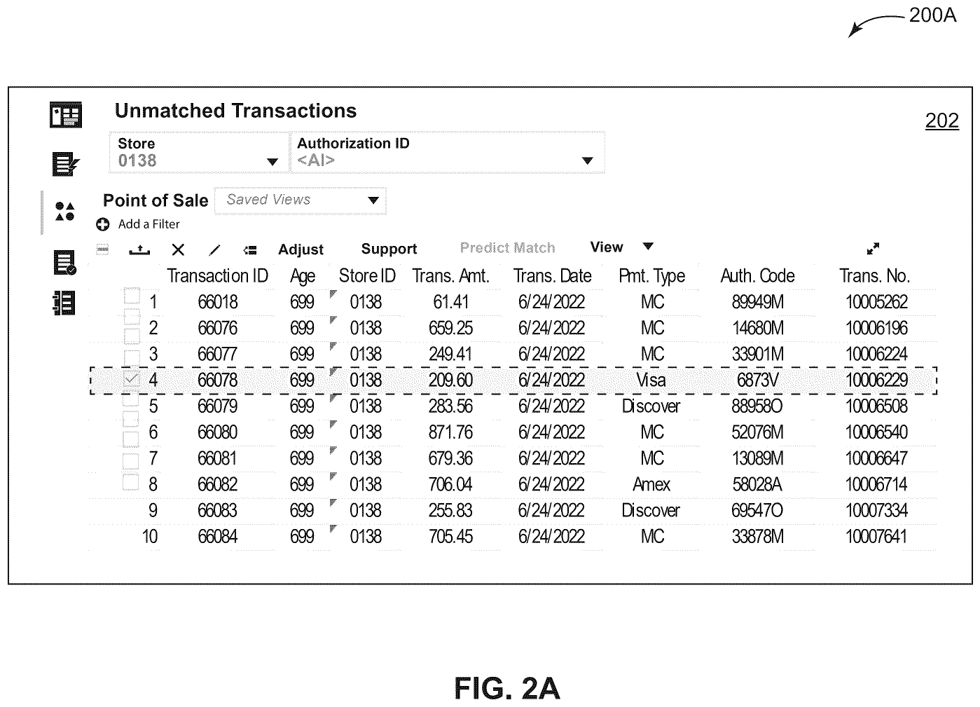

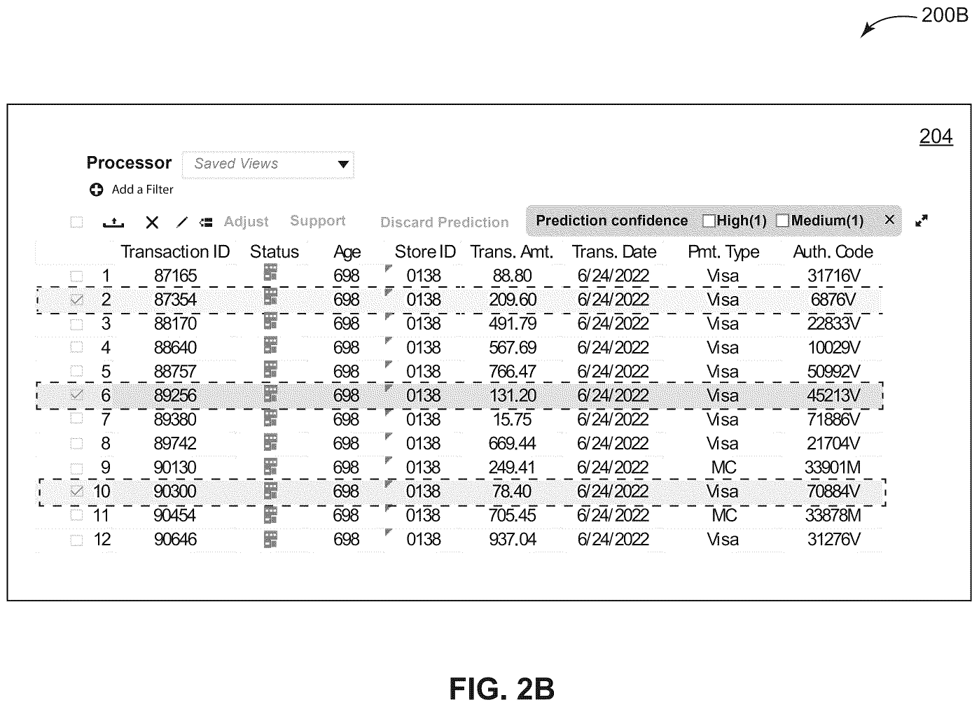

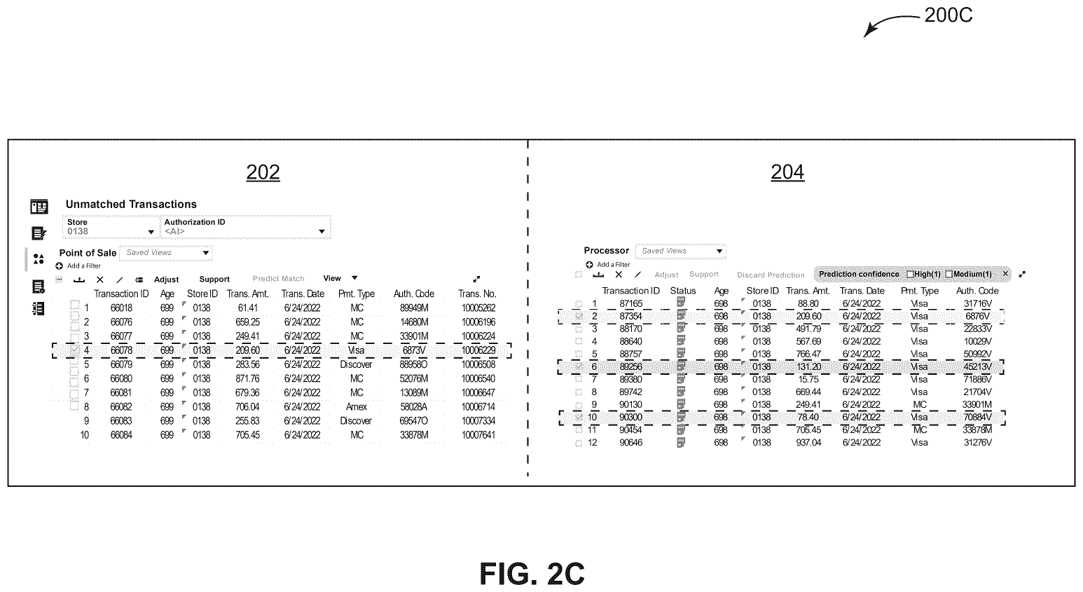

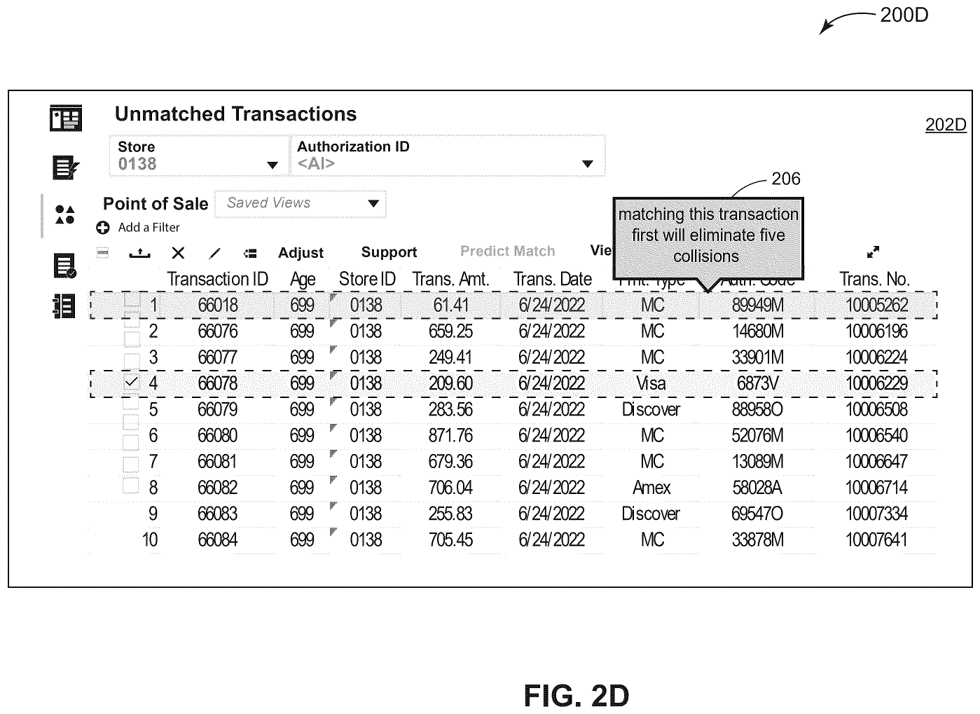

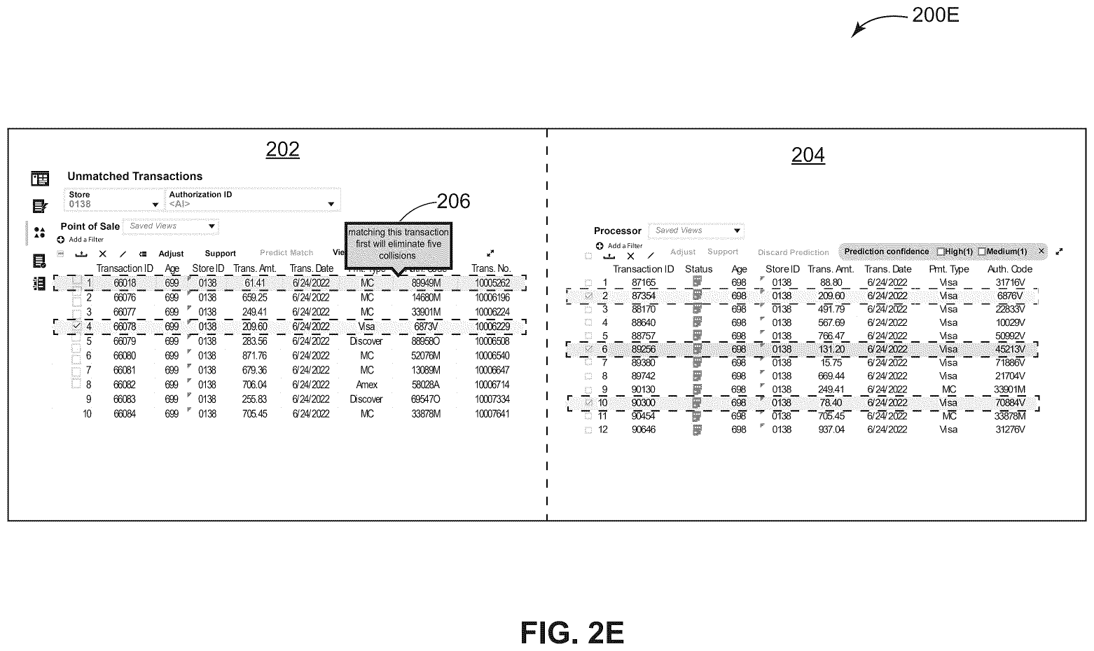

FIGS. 2A and 2B illustrate an exemplary user interface (UI) 200A and 200B, respectively, for displaying sales and banking transactions and ranked matches for a query related to one of the sales transactions. User interface 200A and 200B displays two spreadsheet ledgers, a point-of-sales ledger table 202 (e.g., corresponding to the “first table” in process flowchart 100) In FIG. 2A as UI 200A and a processor (e.g., a bank) ledger table 204 (e.g., corresponding to the “second table” in process flowchart 100) shown as UI 200B in FIG. 2B. Some columns of both point-of-sales ledger table 202 and banking transaction ledger table 204 contain the same type of data. For example, both ledgers have a transaction ID column, transaction amount (“Trans Amt”), “Store ID”, transaction date (“Trans Date”), “Age”, payment type (“Pmt Type” in ledger table 202 and “Tender type” in ledger 204), and authorization code (“Auth Code”). These columns share common data, however “Transaction ID” data are different for each ledger, as one type of transaction ID refers to a sales transaction and the other type refers to a bank deposit transaction. Thus the transaction ID numbers are not the same.

In the example shown in FIGS. 2A and 2B, each transaction row (corresponding to an underlying transaction record) in both ledgers is numbered consecutively. Row #4 in ledger table 202 has been flagged by user selection, indicated by the check mark in the left margin of ledger table 202. The row is highlighted and optionally delineated for ease of identification, such as by a dashed box as shown. By selection of the row in ledger table 202, a search by the data management system described above, for matching transactions in ledger table 204 is initiated to track the movement of the 209.60 sales amount taken in by that particular sale from the point of sale to the processor (bank).

As described above for blocks 104 and 106 in flowchart 100, the data management system concatenates the data contained in the various fields within row #4 of ledger table 202, and embeds the resulting complex string. In accordance with blocks 108 and 110, all rows in ledger table 204 may be similarly embedded, allowing the data management system to perform semantic searches of all bank deposits made within a threshold time period around the date, and time of day in some embodiments, of the sale in question. The data management system may then perform a semantic search of the embedded metadata from each row in ledger table 204 to find similarity between those rows and row #4 in ledger table 202. The semantic search may be informed by machine learning using prior matches or mismatches that were correctly or incorrectly labeled, as indicated by user feedback.

For example, a cosine distance may be determined between row #4 from ledger table 202 and each row of ledger table 204. As noted above, other similarity metrics may be employed by the data management system to determine embedding similarities (e.g., similarities between vector components), such as a Pearson Correlation, Euclidean Distance, Manhattan distance, Minkowski distance, Hamming distance, Chebyshev distance, Jaccard distance, Haversine distance, Sorensen-Dice distance or Levenshtein distance.

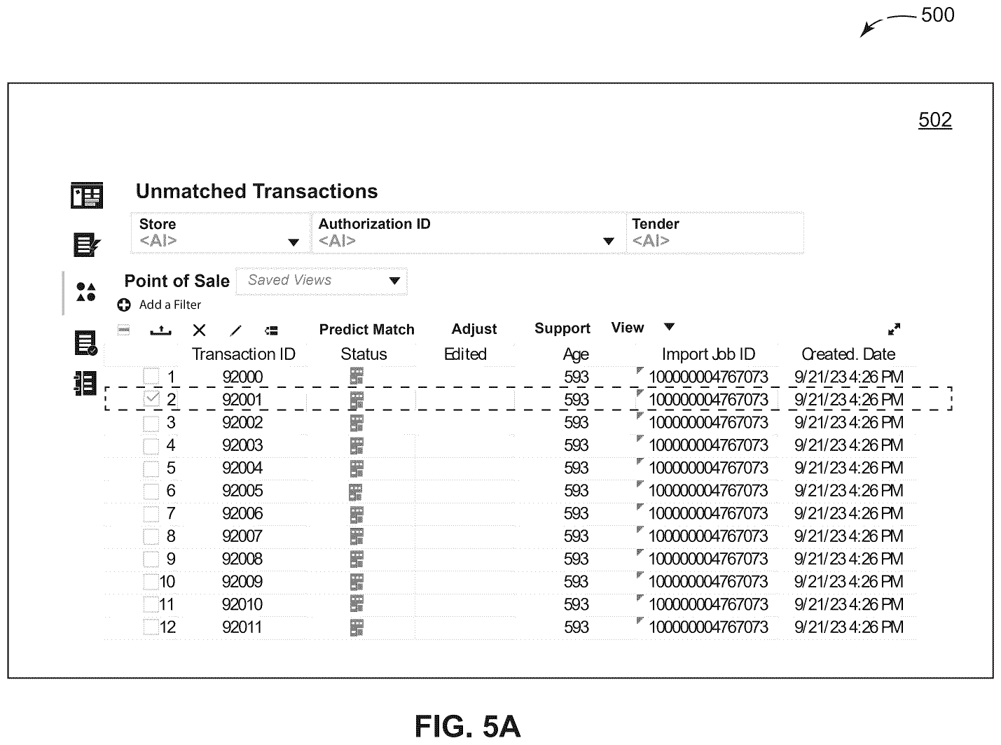

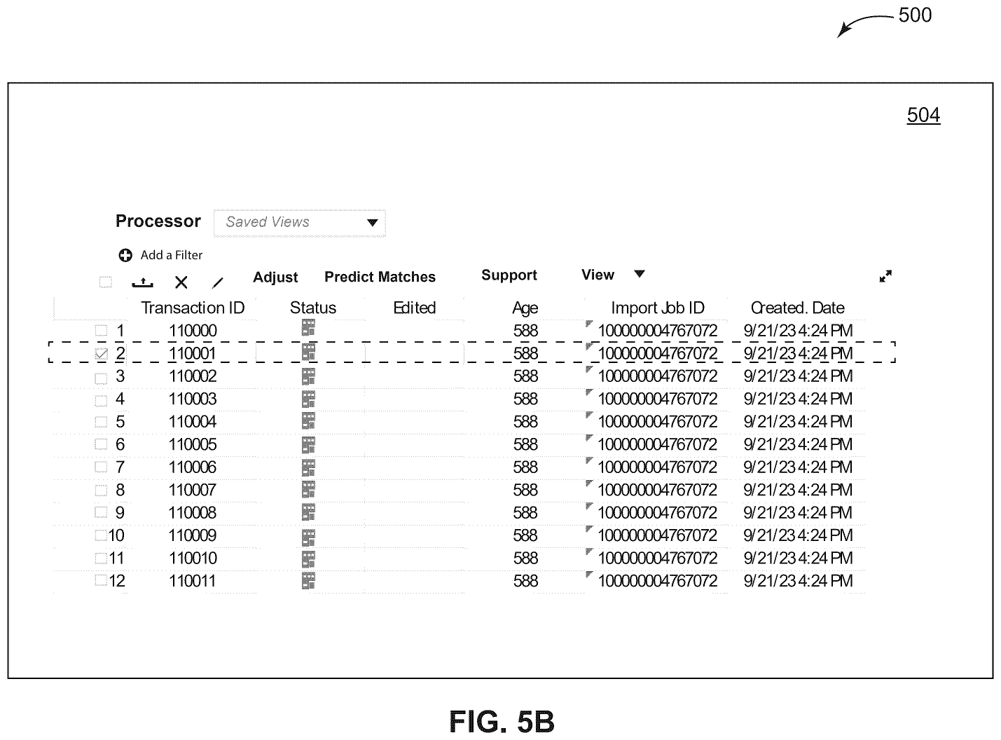

In some implementations, ledger table 204 may contain thousands of processor transaction records. Of those transaction records, there may be a single unique perfect match between processor records and point-of-sale records for the sale transaction in row #4, where all fields in both ledgers are aligned. In other implementations, no processor transaction record in ledger table 204 is found that has a perfect match with the sales transaction in row #4 of ledger table 202. The latter case is shown in FIG. 2B, where three rows are highlighted in ledger table 204, where the matches are not exact, but are the closest found by the machine learning model for these three processor transactions from the potentially thousands of process transactions that were made for the point of sale, for example, within a specified time period. Once the data management system performs the search, the data management system generates or updates a user interface to graphically display the results in UI 200B (see FIG. 5).

In other implementations, point of sale records in ledger table 202 that do not have perfect matches among the thousands of transactions in ledger table 204 may be automatically indicated to the user, for example defined in a configuration interface. Here, the data management system may provide a UI whereby the user may input user-defined rules that involve deciding match levels. Such rules may require a threshold match of metadata attributes that may include, for example, age of transaction, authorization code matching, payment type or other attribute matching requirement. The data management system may compare all transactions in point-of-sale ledger table 202, for example made within a specified time period, to transactions in ledger table 204 and search for matches based on exceeding a threshold match criteria from the user-defined rules for more stringent metadata matching. Transactions in ledger table 204 that are found to have candidate matches may be flagged by the data management system to be presented to the user.

For those point-of-sale transactions that exceed or otherwise satisfy the threshold and are discovered and flagged by the data management system, candidate processor transaction matches, which may each include a set of one or more transactions, from ledger table 204 that fall within certain confidence levels based on transaction amounts may be identified and presented to the user by a color-coded background of the row or other graphical indication that distinguishes the row from other rows that are not matched within the same confidence levels or not matched at all to a source transaction (e.g., from the point of sale transactions).

More transactions could also be displayed, but the data management system may have a directive to only display transactions that have a level of confidence above a specified threshold confidence level. Here, only three transactions meet this criterion. The threshold confidence levels can be user selectable in a configuration interface in some embodiments. These three rows contain bank deposit transaction records that have the closest matches with at least the threshold confidence levels found by the data management system to the sale in question of the potentially thousands of bank deposit records. Each row selected by the data management system (e.g., rows #2, #and #10) in ledger table 204 is highlighted by the data management system, whereby a color of the highlighting is coded by confidence level of the match. Row #2 has a higher match confidence level than rows #6 and #10, and is thus highlighted in a different color than rows #6 and #10, which are highlighted with the same color.

FIG. 2C shows that the UI 200C produces a dual display of both point-of-sale ledger 204 and processor ledge 204 side-by-side for user viewing.

In FIG. 2D, a further option may be displayed by UI 200D to show, to the user, point-of-sale ledger table 202D in according to some implementations. Here, the user initially chooses the transaction in row #4. An interface region 206 may concurrently or subsequently appear, suggesting to the user that there exists another transaction in row #1 that if matched first, that match will eliminate five other potential matches (collisions) with other point-of-sale transactions, making a match for any other unmatched point-of-sale transactions more probable.

FIG. 2E illustrates UI 200E, displaying point-of-sale ledger table 202 and processor ledger table 204 in a side-by-side manner to allow the user to study both ledgers without needing to change screens.

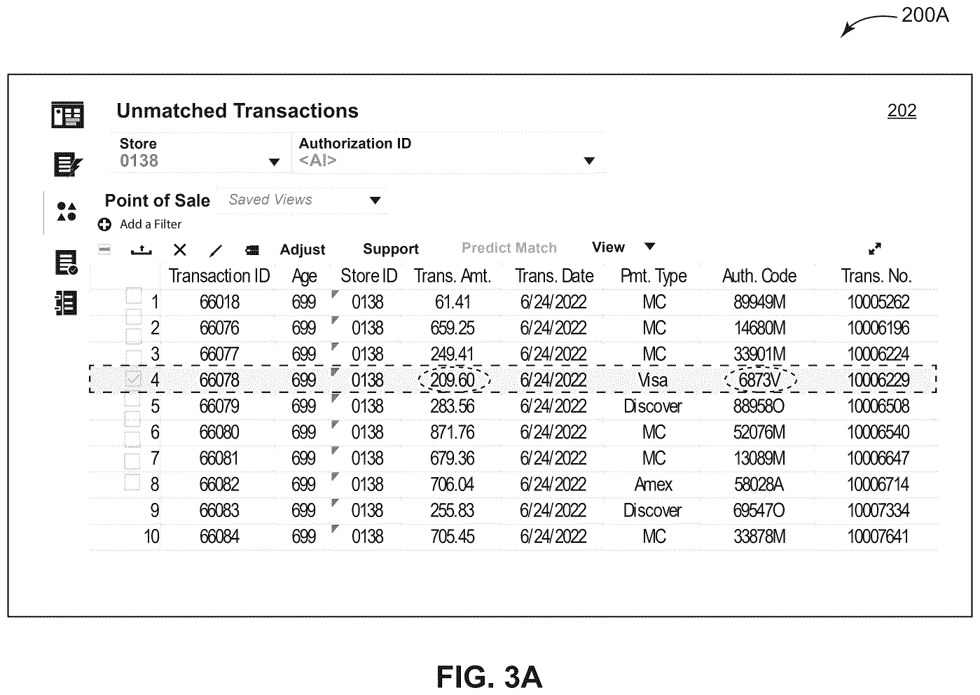

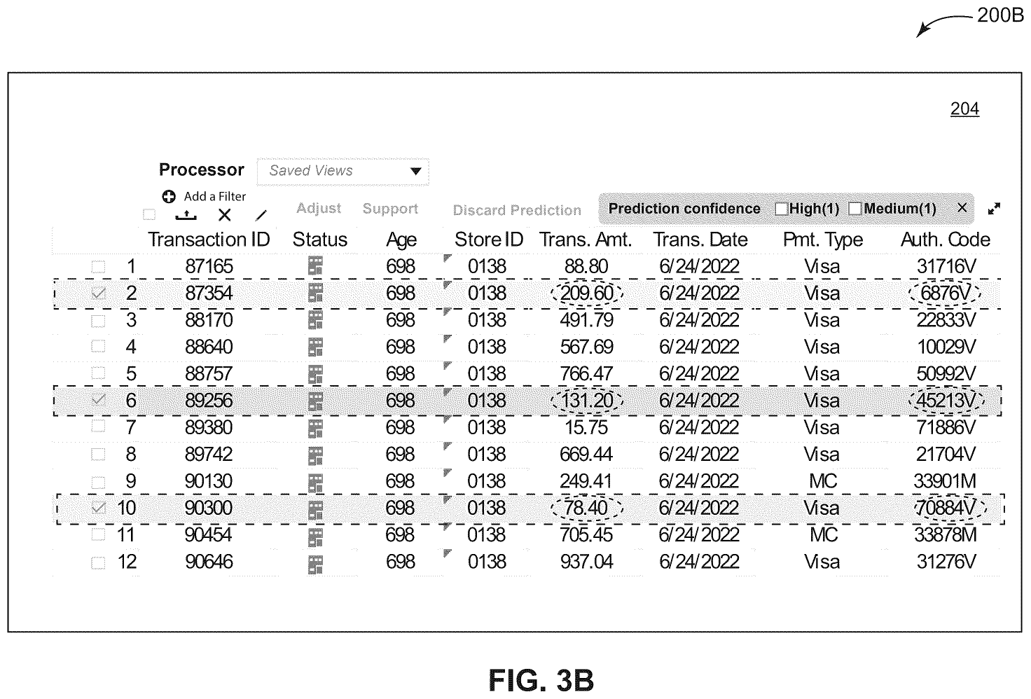

FIGS. 3A and 3B show enlarged views of ledger table 202 and ledger table 204 respectively, where row #4 in ledger table 202 and rows #2, #6 and #10 in ledger table 204 are highlighted. The sales amount of 209.60 is circled in row #4 in FIG. 3A, as well as the authorization code of 6873V. In FIG. 3B, deposit amounts of 209.60 and authorization code 6872V are circled in row #2, whereas deposit amount of 131.20 and authorization code 45213V are circled in row #6. Correspondingly, deposit amount 78.40 and authorization code 70884V are circled in row #10. As the monetary amounts match perfectly between row #2 and row #4 in ledger table 202, but as a minor difference between the authorization codes exists (e.g., 6873V in row #4 in table 202 and 6872V in row #2 in table 204), row #2 is not a perfect match, but determined by the machine learning model to be a very close match. As such, it is highlighted with a color corresponding to the highest confidence level chosen by the user and/or machine learning model.

Regarding rows #6 and #10, neither the individual monetary amounts nor the authorization codes are close matches to row #4. However, the individual monetary amounts, when summed, add to 209.60. Here, the machine learning model may take into account that the sale may have been two separate sales mistakenly or intentionally recorded as a single sale combined, but deposited as two separate deposits. Thus, the user may decide to investigate this possibility. As rows #6 and #10 are linked by the coincidence of their amounts summing to the sales amount, they are considered to have a relatively high confidence level of match, although the authorization codes are different.

In some embodiments, the machine learning model, or a data management system using the machine learning model, may suggest to the user an opportunity to most significantly increase overall match confidence among remaining unmatched transactions if a particular unmatched transaction is matched first, before other matches are attempted. For example, the data management system may find in processor ledger 204 a group of ten transactions made within a day having a five-dollar difference between them. For example, one transaction amount is 24.99, another transaction is 29.99, yet another transaction is 34.99, etc., where all the transactions in the group of ten differ by five dollars. Due to the possible collisions between the individual transactions within the group of ten and the five dollar transaction to form a match with the next higher transaction in the group, the confidence level for potential matches for any transaction in the group is lowered globally.

Without active searching by the user, the data management system may find the five dollar transaction and also find the ten transactions that differ by a five dollar amount, The data management system may flag this situation to the user and suggest that an opportunity exists to raise the confidence level of other matches for this group of ten transactions if the user finds a match between the five dollar transaction, one of the ten transactions in the group and the next higher transaction in the group (that differs by five dollars). If the user follows the suggestion offered by the data management system, then associating the five dollar transaction with any of nine of the ten transactions (except the highest amount in the group) will produce a probable match for these two plus the next higher transaction in the group of ten. Matching these three transactions (the two combined transactions, including the five dollar amount and another transaction, and a target transaction to match against the two combined transactions) eliminates them from the pool of potential matches, thus automatically lowering the uncertainty (and raising the confidence) level of any matches to the remaining eight transactions (to other transactions) as the number of transaction collisions is reduced.

Stated another way, the five-dollar transaction may have collisions with all of the transactions that differ by five dollars from other transactions that are recorded on either ledger table. Assuming that there are ten of these transactions, there are ten potential collisions between these transactions and the one five-dollar transaction that can produce a match to one of the transactions that differs by five dollars. Removing the five-dollar transaction from the pool of unmatched transactions (e.g., by finding a suitable match for it) eliminates these ten collisions for the group of transactions. In addition, two transactions are removed from the original group of unmatched transactions differing by five dollars as they are now matched. The confidence level in matching these remaining eight transactions with other candidate transactions is increased further as any collisions that were possible among the original ten transactions are eliminated as well, lowering uncertainty in matches involving the remaining eight transactions with other unmatched transactions.

As the matching uncertainty is reduced for all unmatched transactions, the data management system may recalculate the probabilities of matching these eight unmatched transactions from the original ten, as well as all of the unmatched transactions in the ledgers, and may find other probable matches that were not considered by the user prior to the recalculation. For the user's initial choice of an unmatched transaction, other transactions in the processor ledger may be predicted to have a higher level of confidence for matching to the user's original choice, and these may be displayed by color-coded highlighting indicating that they are now high confidence matches, which might not have appeared prior to the recalculation.

In some embodiments, the user may choose to discard certain predicted matches. Here the user may manually discard certain matches from the pool of unmatched transactions, for example, that from some indications do not belong in the pool of unmatched transactions for an unmatched point-of-sale transaction.

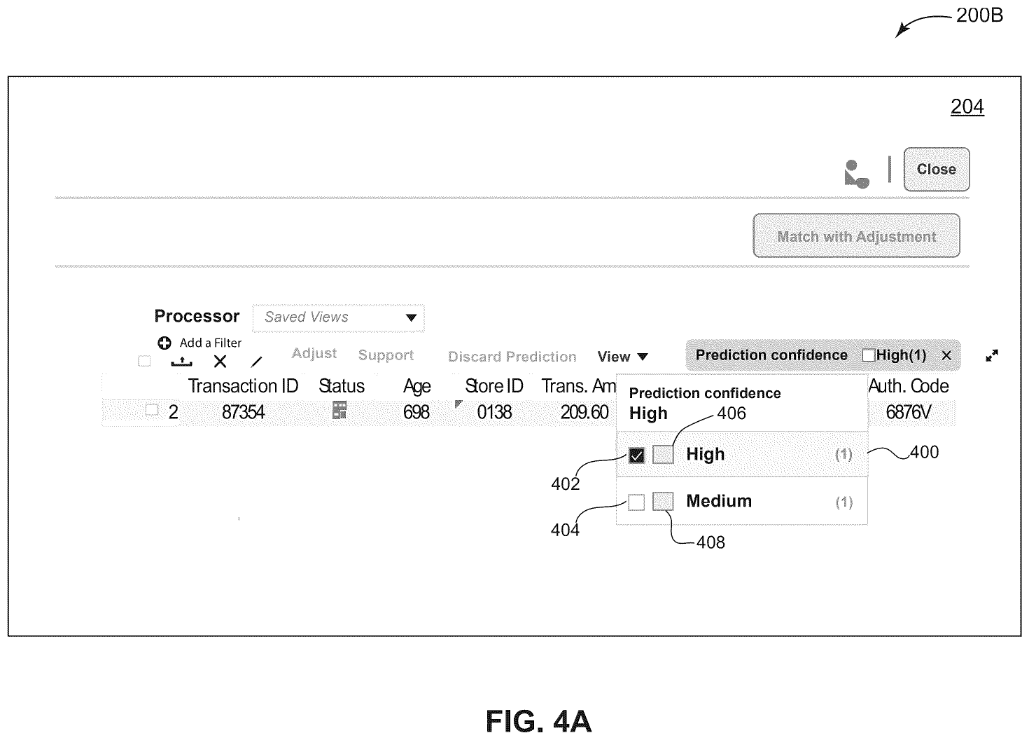

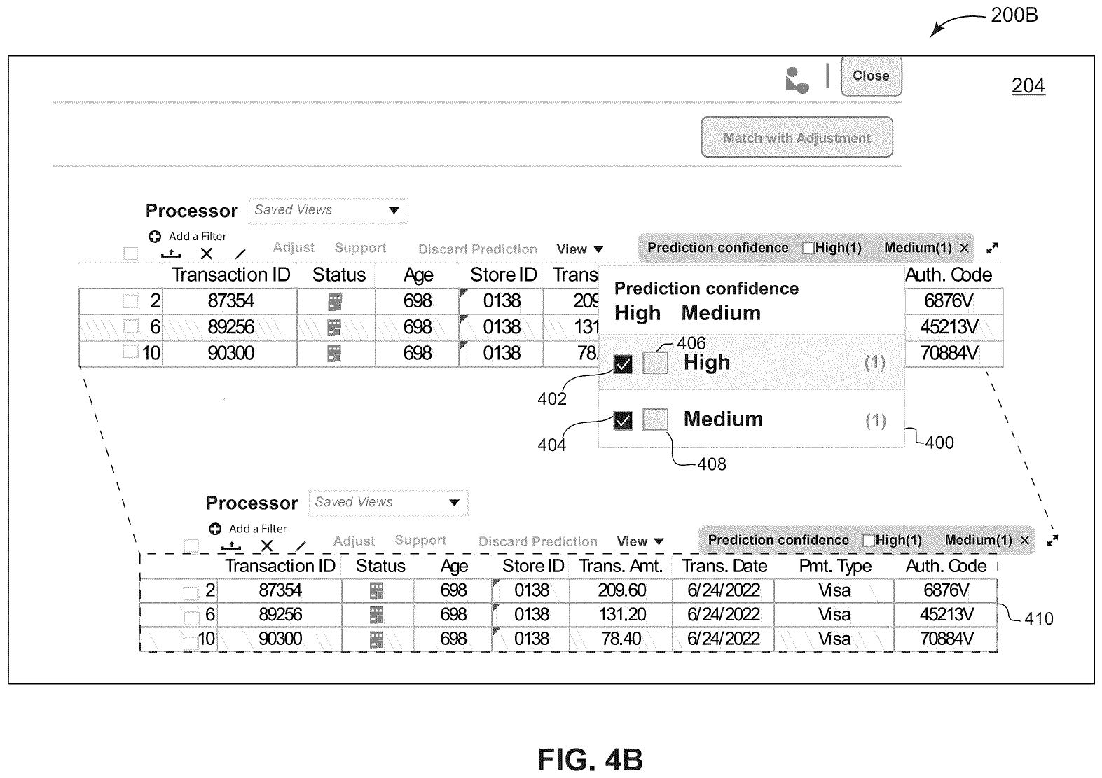

FIG. 4A shows a portion of UI 200B whereby a match selection feature 400 of UI 200 is opened by the user. In some embodiments, match selection feature 400 is a drop-down menu that presents match confidence level display options to the user, for graphical display of only those records having the closest matches to the query. In some embodiments, check boxes 402 and 404 are present to respectively display all matches having confidence levels above a high confidence threshold or display all matches having confidence levels above a medium confidence threshold. User selection is made by checking one or both check boxes 402 and 404. The user input prompts the data management system to flag which records in ledger table 204 are to be graphically displayed. In some embodiments, color swatches 406 and 408 may be displayed to show the user which colors of a preselected color-coded scale will highlight records having a high confidence match (color swatch 406) and what color(s) will highlight those records having a medium confidence match (color swatch 408).

In the exemplary embodiment shown in FIG. 4A, check box 402 is checked by the user. The data management system causes only row #2 to display, as the record for row #2 meets a minimum threshold of match confidence for the closest match to the query discussed above, therefore having highest confidence weight of all the records in ledger table 204.

FIG. 4B shows a portion of UI 200B where check boxes 402 and 404 in display preference feature 400 are both checked by the user in an alternative option prompting the display of all records having close matches to the query. The selection of all records meeting a medium confidence level threshold is enabled by checking check box 404, enabling highlighting of close-match records whose match confidence levels fall within a threshold value. The highlight color is displayed to the user as color swatch 408.

User selection preference is again input to the data management system, including a selection that all records having match confidence above the predetermined threshold are to be displayed. As indicated in FIGS. 3A and 3B, rows #2, #6 and #10 are the only rows in ledger table 204 meeting the match criteria, these rows are displayed, whereas all other rows are hidden. This is shown as a row list 410, shown as an inset of the figure. In alternative embodiments, all other rows may be displayed without highlighting, where the closest matched rows may be preferentially displayed at the top of the list.

FIGS. 5A and 5B show a further embodiment of the user interface, UI 500 for unmatched transactions, comprising Point-of-sale ledger table 502 is shown in FIG. 5A. Ledger table 502 is similar to ledger table 202 shown in FIG. 2A. with the exception that a “Status” column, an “Edited” column and an “Import Job ID” column are added. While the “Predict Matches” option in the tool bar above the data rows was already present in ledger table 202, it has been moved to the left to increase its importance to the user. In ledger table 502, fewer data columns are present in comparison with ledger table 202 as the “Store ID”, “Transaction Amount”, “Payment Type”, and “Authorization Code”columns are omitted.

In FIG. 5B, Processor ledge table 504 is shown. In the illustrative embodiment, column labels are the same as in ledger table 502. Here, a group of transactions are listed as having been flagged by the data management system for not having been matched up with point-of-sale transactions.

Data in the rows of ledger 502 show a list of point-of-sale transactions that have been flagged by the data management system as not having a direct or perfect match with the transactions. Referring to ledger table 502 in FIG. 5A, the user may select one or more point-of-sale transactions by checking the boxes adjacent to the row numbers. Such a selection is shown in FIG. 5A, where row #2 has been checked. The selection of row #2 may prompt the data management system to search for transactions that surpass a preset probability threshold or confidence level for matching point-of-sale transaction #2.

Similarly for processor ledger table 504 in FIG. 5B. one or more unmatched transactions are displayed. Here, the user has a choice of selecting a source (e.g., point-of-sale) transaction as an anchor transaction, or a transaction in ledger table 504 as an anchor transaction. A particular transaction may be selected by checking one or more of the row numbers. As shown in the illustrative embodiment, a transaction in row #2 has been selected in both point-of-sale ledger table 502 and processor ledger table 504. While the data management system is prompted to search for threshold transaction matches for the chosen point-of-sale transaction, the selection of row #2 in processor ledger table 504 may also prompt the data management system to search for point-of-sale transactions that surpass a preset probability threshold or confidence level for matching transaction #2.

By enablement of such bidirectional prediction of matches, the user can have the ability to see more potential matches than would be possible in a unidirectional matching scheme as described above. Here, transaction anchoring (from processor ledger table 504) may enable locating potential matches that the data management system finds because the search is not limited to just the one point-of-sale transaction that the user is initially interested in (e.g., choice of row #2 in ledger table 502). The processor anchor (e.g., a transaction selected in processor ledger table 504) can show the user other point-of-sale transactions that may also need to be considered by the user as candidate matches for the particular transaction from ledger table 504 (e.g., choice of row #2 in ledger table 504), whereas if not suggested by the data management system, the user would be unaware of these other potential match choices. Thus, bidirectional prediction of matches can be supported based on user selection of a source (e.g., point-of-sale) transaction in ledger table 502, which can trigger automatic selection of candidate matches in ledger table 504. In turn, automatic selection of candidate matches in ledger table 504 can trigger more candidate transactions in ledger table 502. None of these automatic selections may have been apparent to the user at the beginning of the matching process or are supported by prior systems. Here, the data management system may calculate the automated predictions that may have greater weight than the human-made choice of one or more unmatched transactions based on the machine learning model's greater ability to perform quantitative predictions rather than intuitive guesses that the human user may rely upon.

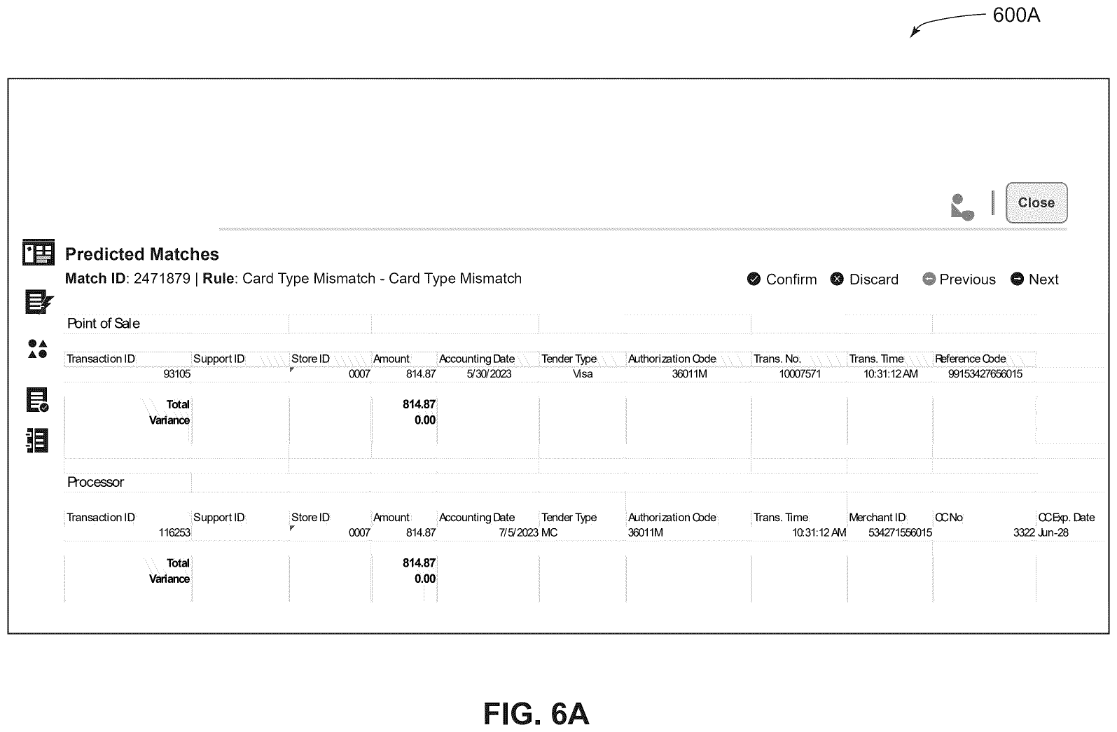

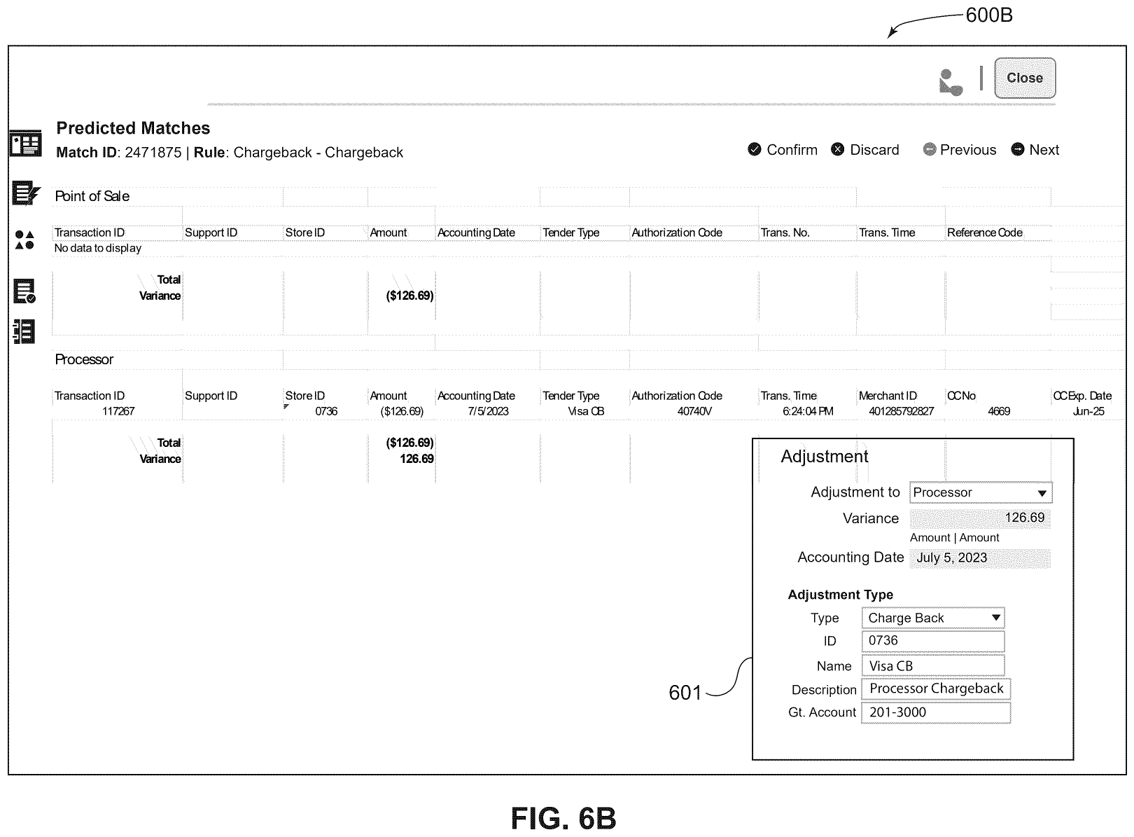

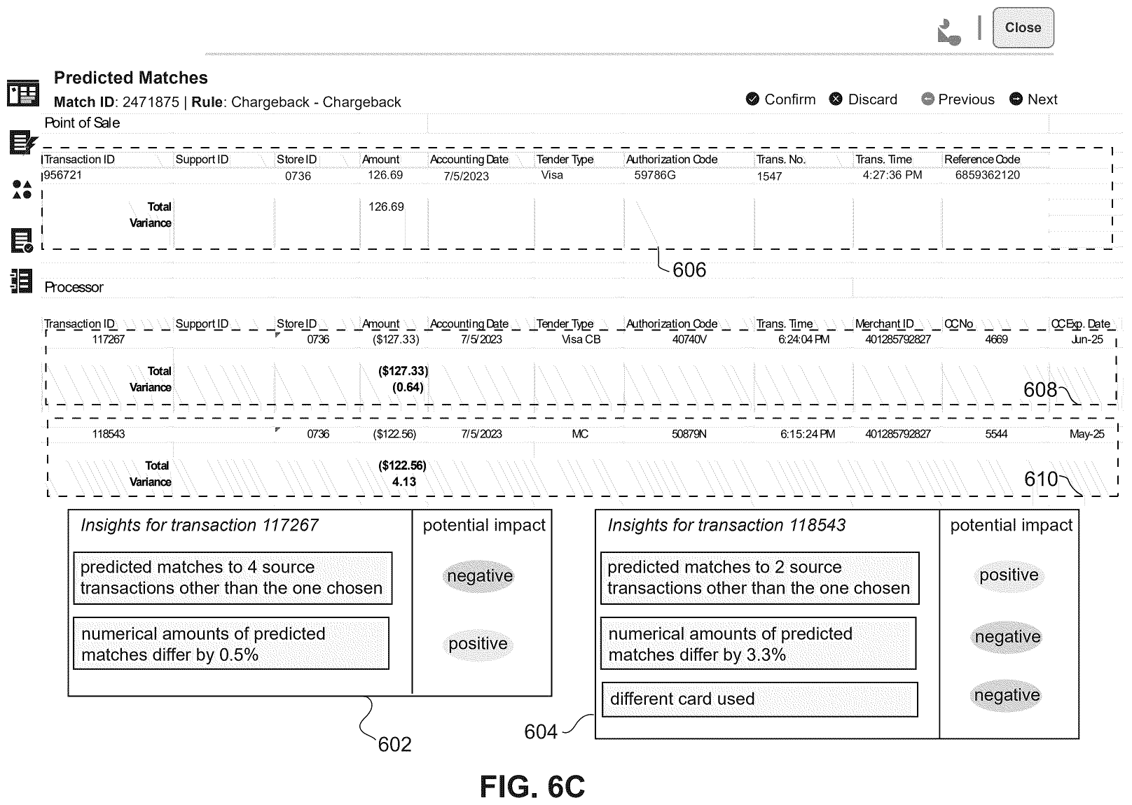

In some embodiments, the user may choose row #2 in point-of-sale ledger table 502, then select the “predict matches” option above ledger table 502. In at least one embodiment, instead of a tabular presentation of predicted matches as shown in ledger table 204 in FIG. 2B, the data management system through UI 500 may generate an interface region, for example as shown as interface region 600A in FIG. 6A. Here, the interface provides the ability for user review of one potential match at a time, and by selecting the “next” or “previous” has the ability to display one candidate match at a time. In at least one embodiment, the user also may confirm or discard the candidate match by choosing the “confirm”or “discard”options in the tool bar shown in FIG. 6A.

In at least one embodiment, interface region 600A also displays the type or category of match. For example, a particular candidate match is entered with an ID number (e.g., Match ID 2471879). A match rule is displayed for the user as well, adjacent to the match ID. In the illustrative embodiment, the displayed match rule that is violated is “card type mismatch-card type mismatch”, where both the point-of-sale transaction and transaction have the same amount, but card type is different (e.g., Visa on the point-of-sale side and MC on the processor side). The difference may be due to human error or another reason. Here, the user has the option of tracing the entries in both ledgers and making a correction and/or configuring the tool to automatically make corrections when a confidence level is above a threshold and/or automatically accept any corrections that are made when confidence is above a threshold.

FIG. 6B shows another example embodied in interface region 600B. Here, a large variance has been detected because no point of sale transaction has been detected. The match between a processor transaction and a blank point of sale transaction may be suggested based on a “chargeback” rule, which may be used in scenarios where an overcharge is reimbursed to the customer or otherwise when there is no matching point of sale transaction. In some examples, an adjustment interface region 601 may appear indicating additional data regarding details of the adjustment.

FIG. 6C shows an additional feature to guide the user based on insights on the proposed matches that are made by the model. Such insights would otherwise not be apparent to the user, consideration of such insights may enable the user to make more probable matches. Here, the UI 600C shows the user further choices, but such choices are found by the model to provide the user with objective metadata that can enable more pointed choices that were not initially apparent when the user was presented with the initial selection of possible matching transactions in response to the point-of-sale query (e.g., see FIGS. 2A and 2B). The UI may display additional interface regions, as shown by interface regions 602 and 604 in FIG. 6C. Interface regions 602 and 604 contain metadata that provides guidance to the user for choosing one of the processor transactions displayed in the initial response to the query (e.g., see FIG. 2B).

Here, the user may have made an initial query for a particular point-of-sale transaction, for example, as shown in FIG. 2A. Once processor transactions are found that collide with the point-of-sale transaction, the model perform a second analyses of the processor transactions identified in the initial response to the point-of-sale query. The processor may find one or more other transactions that collide with the initial set of proposed matches. may find one or more processor transactions that collide with the point-of-sale transaction, as shown in FIG. 2B (here, the most probable transactions are highlighted).

In FIG. 6C, two different unmatched processor transactions are shown in the (e.g., transaction ID 117267 and 118543). Interface regions 602 and 604 may be generated by the model to inform the user about model-generated insights regarding the selected processor transactions (that the user may be considering matching to the point-of-sale transaction) generated “behind the scenes”, that is, optionally without prompting by the user. Such insights are based on secondary computations made by the model on the set of transactions initially predicted and proposed for the user query.

In one implementation, exemplary insights are presented in the interface region 602 for transaction 117267, which may have been among several unmatched processor transactions found by the model in response to the point-of-sale query. Here, the model may have found four other source (e.g., point-of-sale) transactions that processor transaction 117267 may also match beside the source transaction for which the potential match was made originally. The first insight makes these collisions known to the user, who may otherwise have remained unaware of these potential matches. In various embodiments, interface 600C may include an option to drill-down into the other point of sale transactions that potentially match the processor transaction. In some implementations, insights are further determined to have a negative or positive impact on the confidence level of the choice of that transaction as a match for the point-of-sale transaction. In the case of the first insight listed, choosing transaction 117267 as a match to the point-of-sale transaction in question would entail a greater uncertainty of match due to the four other collisions.

On the other hand, a second insight brings to the attention of the user that the numerical deviation of transaction 117267 from transaction 956721 is approximately 0.5%. Here, the potential impact of the numerical deviation is determined to be positive in light of the other closest matched transaction, 118543, which has a numerical deviation from transaction 956721 of approximately 3.3%.

Interface region 604 refers to the second processor transaction, transaction 118543. Here, the model has predicted two source (point-of-sale) transactions that could also match processor transaction 118543. Again, these two source transactions were not immediately apparent to the user without being indicated on the UI. In various embodiments, interface 600C may include an option to drill-down into the other point of sale transactions that potentially match the processor transaction. The fact that there are only two other potential matches for transaction 118543 is indicated as a positive reason to choose transaction 118543 over transaction 117267, because transaction 118543 is more uniquely matched to transaction 956721 relative to other candidate transaction(s).

The two additional example insights listed in interface region 604 are shown to have a negative impact rating, but do inform the user as to the potential impact of matching transaction 118543 to transaction 956721. Here, an indication that transaction 118543 differs from transaction 956721 by 3.3% is viewed as a negative sign for matching in comparison with transaction 117267. Also, the fact that a different card was used for transaction 118543 is also viewed as a negative sign for matching in comparison with transaction 117267, which uses the same card.

### HYBRID MODELS FOR MATCHING

Transaction reconciliation may be supported by a trained machine learning model or content classifier that is trained to create vector embeddings and/or use other machine learning classification algorithms such as Random Forest, Decision Tree, Neural Network, Naive Bayes, Generalized Linear Model, etc. to match content from different ledgers and search for matches between the content that have occurred. In various embodiments, a hybrid machine learning model may use multiple techniques together for matching transactions. The machine learning model may be trained on manual activity for prior matches that have been made, such as user selections that set(s) of transaction(s) from a ledger match set(s) of other transaction(s) from another ledger.

In one embodiment, a hybrid machine learning model uses a random forest technique to generate decision trees based on randomly selected subsets of data. Due to the different training data, the trees account for subtle features in the data that may be matched in small subsets that appear in training data for some trees but not for others. The features accounted for by each decision tree may differ, and the trees predict a classification or strength of the match for input pairs of data. Output predictions from multiple trees may be aggregated or combined together into a predicted match and a confidence score for the predicted match. A user interface accessible from the ledger matching interface may provide options for tuning hyperparameters of the random forest, such as a number of decision trees to use, a maximum depth of the decision trees (e.g., to balance prediction efficiency versus accuracy), a minimum number of samples used for a decision branch in the decision trees, and/or a maximum number of features to be considered in each decision branch of the decision trees.

Decision trees may be used in a hybrid machine learning model with or without using random forest techniques. Decision trees may include a depth of decision branches trained to classify training data such that different samples are on each side of the branch. The branches may extend a depth into the decision tree such that multiple decisions are made, optionally with different data features or components of a vector embedding being considered at different levels of the tree. In one example, a branch of the decision tree may reduce a number of candidate matches of the a ledger based on transaction amounts and another branch of the decision tree may output a classification that contributes to a higher confidence of one set of records over another set of records for matching. A user interface accessible from the ledger matching interface may provide options for tuning hyperparameters of the decision trees, such as a number of decision trees to use, a maximum depth of the decision trees (e.g., to balance prediction efficiency versus accuracy), a minimum number of samples used for a decision branch in the decision trees, and/or a maximum number of features to be considered in each decision branch of the decision trees.

Neural networks may be used in the hybrid machine learning model additionally or alternatively to random forest techniques and/or decision trees. A neural network is a machine learning model that includes layers of inputs and outputs as well as processing components for generating the outputs at each layer. The processing components may be trained to make specific determinations about the data coming into the layer, such as which other records may be combined with the record to achieve a possible match in transaction amount (e.g., reducing a number of records for consideration by other layers), selecting a match from a plurality of candidate matches, or what is the confidence of the selected match as compared to other candidate matches. The inputs to each layer may include vector embeddings, features, or components of data determined based on the table(s) or record(s) presented for matching. The outputs of each layer may include results of the processing components, and the processing components can be modified and optimized based on the inputs to produce outputs that are more predictive in different scenarios. Outputs of one layer may be fed forward to a next layer of the neural network, optionally with previous inputs also being provided to the next layer. In this manner, lower layers of the neural network may have more comprehensive inputs and may be able to make more comprehensive comparisons, such as determining respective confidences of different candidate matches. Labeled data may be provided to any processing component in a neural network and/or to the neural network as a whole to better train the processing component or create or organize layers to make the layer-specific decisions about the input set of data. The networks may include transformer networks for natural language processing of text present in transactions, and may feed forward results from the natural language processing to a layer for predicting a confidence of a match. A user interface accessible from the ledger matching interface may provide options for tuning hyperparameters of the neural networks, such as a number of processing components to use at each layer, a maximum number of layers, training data or data features or components to use at each layer, and/or a maximum number of features to be considered at each layer.

A Naïve Bayes algorithm may be used in the hybrid machine learning model additionally or alternatively to random forest techniques, decision trees, and/or neural networks. The Naïve Bayes algorithm may predict a likelihood or confidence of matches based on a historical probability that data having similar characteristics to given data was labeled as matched as compared to the historical probability that data having similar characteristics to the given data was not labeled as matched. The Naïve Bayes algorithm may be tuned with information about labeled matches to improve knowledge of historical probabilities. In one example, a naïve bayes algorithm is used to determine a higher confidence of one set over another for matching to a source record based on a historical probability of other sets of records being labeled as matches to other records based on similar characteristics than were used between the sets being matched and the source record. A user interface accessible from the ledger matching interface may provide options for tuning hyperparameters of the Naïve Bayes algorithm, such as a number of records to consider for a candidate match and/or a number or selection of features to use for matching records.

A generalized linear model may be used in the hybrid machine learning model additionally or alternatively to random forest techniques, decision trees, neural networks, and/or the Naïve Bayes algorithm. The generalized linear model may use linear regression to model various types of distributions of historical matches for predicting a probability that a new candidate match having similar characteristics is within the distribution or outside the distribution to be considered as a match. The generalized linear model may use various distributions such as normal, binomial, and/or Poisson distributions to model which input candidate matches are selected based on various input characteristics of competing candidate matches, with selected matches being modeled inside the distribution and unselected matches being modeled outside the distribution. The distribution may then be used to predict a likelihood that a new candidate match is within the distribution or outside the distribution. In one example, a generalized linear model is used to determine a higher confidence of one candidate set over another as a match to a source record based on a historical distribution of sets of records matched to source records based on characteristics similar to the source record. A user interface accessible from the ledger matching interface may provide options for tuning hyperparameters of the generalized linear model, such as available distributions to include, a number of records to consider for a candidate match, and/or a number or selection of features to use for matching records.

### DATA MANAGEMENT SYSTEM

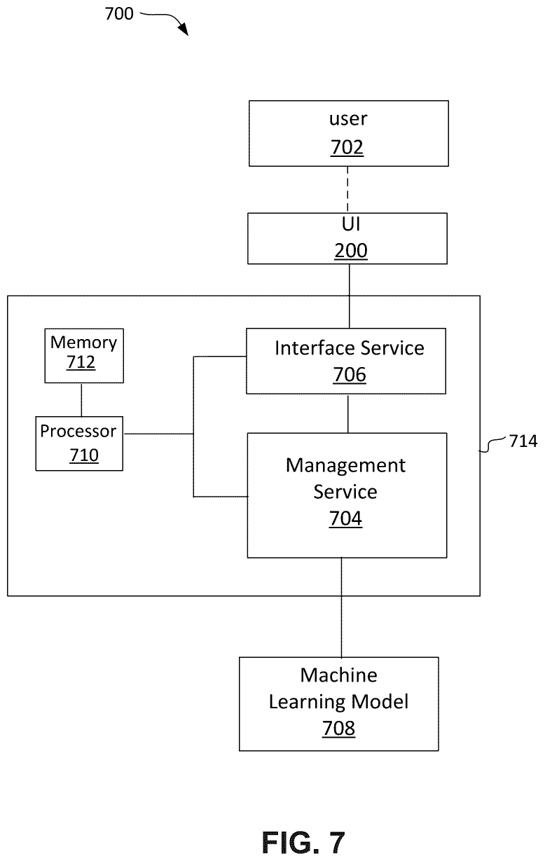

FIG. 7 illustrates a block diagram for a data management system 700 (hereinafter, system 700). In some embodiments, system 700 comprises various interconnected software components including data management service 704, interface service 706 and machine learning model 708. In some embodiments, interface service 706 receives inputs from user 702 via user interface (UI) 200A, for example, and passes a request (“user query”) for matching records to data management service 704. Here, UI 200A is an interactive display on a device screen that is presented to user 702. Examples of UI 200A have been described above, and presented in FIGS. 2, 3A-B, and 4A-B. All software components are processed by a processor 710 and memory 712 coupled to the memory. In the exemplary system depicted in FIG. 7, software comprising data management service 704 and interface service 706 are stored on a storage device 714 comprising non-transitory computer-readable media, which is accessible by processor 710. Machine learning model 708 may be accessed as a cloud-based service or local service.

Data management service 704 may direct user queries to machine learning model 708 for determining semantic similarity, as well as receiving output from the machine learning model 708. In various embodiments, data management service 704 controls display options chosen by user 702. For example, user choices made in drop-down feature 400 in UI 200B (shown in FIGS. 4A and 4B) for display of records meeting confidence level thresholds for query matches, and vector embeddings returned by the machine learning model may be scored by the data management service 704 and used by interface service 706 to display selected matches. Interface service 706 may receive direct input from UI 200A or 200B, and store the inputs in variables within a memory, to be read by data management service 704.

### COMPUTER SYSTEM ARCHITECTURE

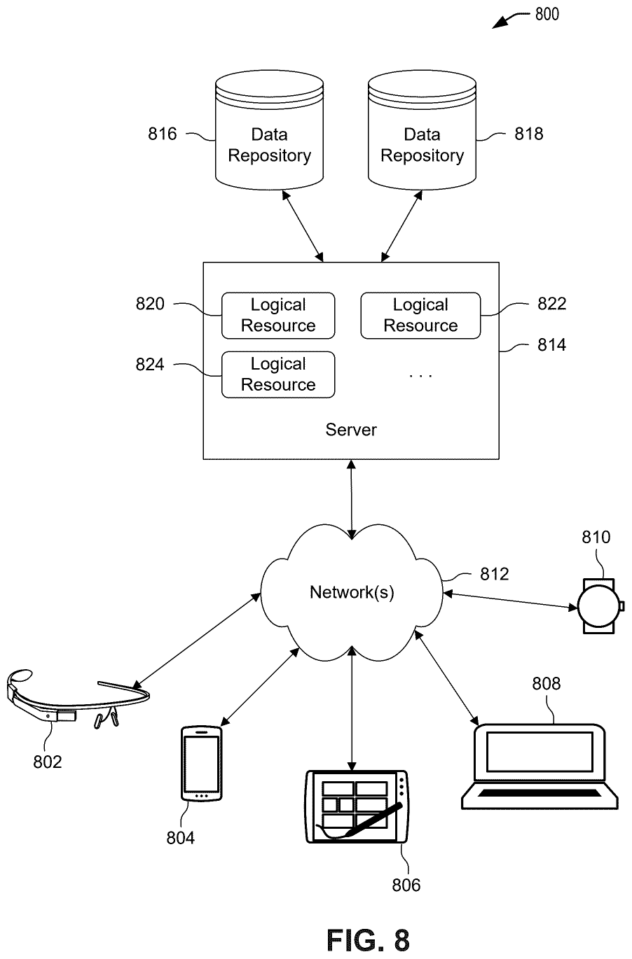

FIG. 8 depicts a simplified diagram of a distributed system 800 for implementing an embodiment. In the illustrated embodiment, distributed system 800 includes one or more client computing devices 802, 804, 806, 808, and/or 810 coupled to a server 814 via one or more communication networks 612. Clients computing devices 802, 804, 806, 808, and/or 810 may be configured to execute one or more applications.

In various aspects, server 814 may be adapted to run one or more services or software applications that enable techniques for determining matches between records of different systems based on aggregate record data, and graphically marking potentially matched groups of data along with predicted confidence levels.

In certain aspects, server 814 may also provide other services or software applications that can include non-virtual and virtual environments. In some aspects, these services may be offered as web-based or cloud services, such as under a Software as a Service (SaaS) model to the users of client computing devices 802, 804, 806, 808, and/or 810. Users operating client computing devices 802, 804, 806, 808, and/or 810 may in turn utilize one or more client applications to interact with server 814 to utilize the services provided by these components.

In the configuration depicted in FIG. 8, server 814 may include one or more components 820, 822 and 824 that implement the functions performed by server 814. These components may include software components that may be executed by one or more processors, hardware components, or combinations thereof. It should be appreciated that various different system configurations are possible, which may be different from distributed system 800. The embodiment shown in FIG. 8 is thus one example of a distributed system for implementing an embodiment system and is not intended to be limiting.

Users may use client computing devices 802, 804, 806, 808, and/or 810 for techniques for determining matches between records of different systems based on aggregate record data, and graphically marking potentially matched groups of data along with predicted confidence levels in accordance with the teachings of this disclosure. A client device may provide an interface that enables a user of the client device to interact with the client device. The client device may also output information to the user via this interface. Although FIG. 8 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 812 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 812 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 814 may be composed of one or more general purpose computers, specialized server computers (including, by way of example, PC (personal computer) servers, UNIX® servers, LINUX® servers, mid-range servers, mainframe computers, rack-mounted servers, etc.), server farms, server clusters, a Real Application Cluster (RAC), database servers, or any other appropriate arrangement and/or combination. Server 814 can include one or more virtual machines running virtual operating systems, or other computing architectures involving virtualization such as one or more flexible pools of logical storage devices that can be virtualized to maintain virtual storage devices for the server. In various aspects, server 814 may be adapted to run one or more services or software applications that provide the functionality described in the foregoing disclosure.

The computing systems in server 814 may run one or more operating systems including any of those discussed above, as well as any commercially available server operating system. Server 814 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 814 may include one or more applications to analyze and consolidate data feeds and/or event updates received from users of client computing devices 802, 804, 806, 808, and/or 810. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 614 may also include one or more applications to display the data feeds and/or real-time events via one or more display devices of client computing devices 802, 804, 806, 808, and/or 810.

Distributed system 800 may also include one or more data repositories 816, 818. These data repositories may be used to store data and other information in certain aspects. For example, one or more of the data repositories 816, 818 may be used to store information for techniques for determining matches between records of different systems based on aggregate record data, and graphically marking potentially matched groups of data along with predicted confidence levels. Data repositories 816, 818 may reside in a variety of locations. For example, a data repository used by server 814 may be local to server 814 or may be remote from server 814 and in communication with server 814 via a network-based or dedicated connection. Data repositories 816, 818 may be of different types. In certain aspects, a data repository used by server 814 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 816, 818 may also be used by applications to store application data. The data repositories used by applications may be of different types such as, for example, a key-value store repository, an object store repository, or a general storage repository supported by a file system.

In one embodiment, server 814 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

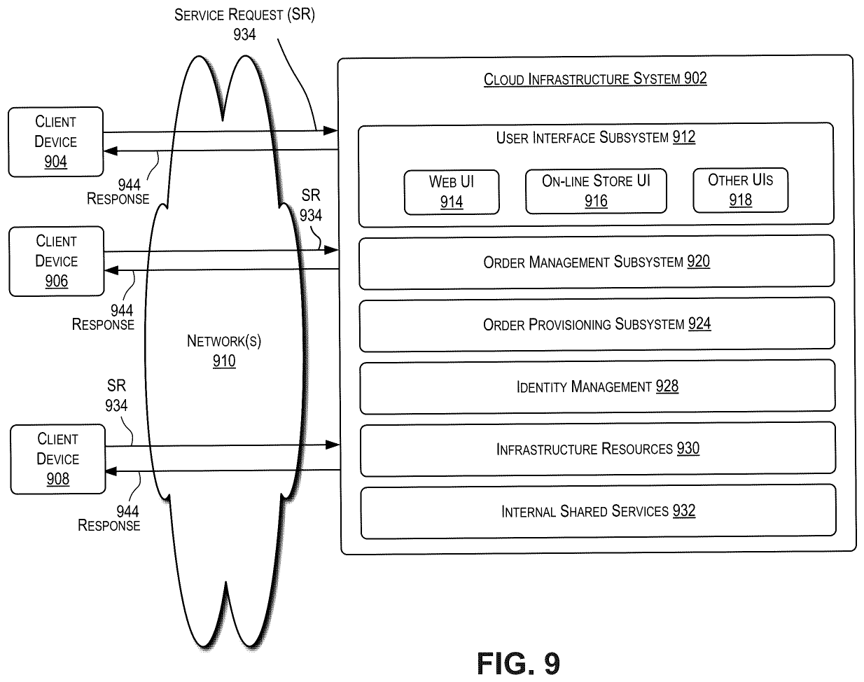

FIG. 9 is a simplified block diagram of a cloud-based system environment in which matches may be determined between records of different systems based on aggregate record data, and potentially matched groups of data may be graphically marked along with predicted confidence levels, in accordance with certain aspects. In the embodiment depicted in FIG. 9, cloud infrastructure system 902 may provide one or more cloud services that may be requested by users using one or more client computing devices 904, 906, and 908. Cloud infrastructure system 902 may comprise one or more computers and/or servers that may include those described above for cloud infrastructure system 912. The computers in cloud infrastructure system 902 may be organized as general purpose computers, specialized server computers, server farms, server clusters, or any other appropriate arrangement and/or combination.

Network(s) 910 may facilitate communication and exchange of data between clients 904, 906, and 908 and cloud infrastructure system 902. Network(s) 910 may include one or more networks. The networks may be of the same or different types. Network(s) 910 may support one or more communication protocols, including wired and/or wireless protocols, for facilitating the communications.

The embodiment depicted in FIG. 9 is only one example of a cloud infrastructure system and is not intended to be limiting. It should be appreciated that, in some other aspects, cloud infrastructure system 902 may have more or fewer components than those depicted in FIG. 9, may combine two or more components, or may have a different configuration or arrangement of components. For example, although FIG. 9 depicts three client computing devices, any number of client computing devices may be supported in alternative aspects.

The term cloud service is generally used to refer to a service that is made available to users on demand and via a communication network such as the Internet by systems (e.g., cloud infrastructure system 902) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 910 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 902 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 902 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 902. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 902. Cloud infrastructure system 902 then performs processing to provide the services requested in the tenant's subscription order. Cloud infrastructure system 902 may be configured to provide one or even multiple cloud services.

Cloud infrastructure system 902 may provide the cloud services via different deployment models. In a public cloud model, cloud infrastructure system 902 may be owned by a third party cloud services provider and the cloud services are offered to any general public tenant, where the tenant can be an individual or an enterprise. In certain other aspects, under a private cloud model, cloud infrastructure system 902 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 702 and the services provided may be shared by several organizations in a related community. Various other models such as hybrids of the above mentioned models may also be used.

Client computing devices 904, 906, and 908 may be of different types (such as devices 802, 804, 806, and 808 depicted in FIG. 8) and may be capable of operating one or more client applications. A user may use a client device to interact with cloud infrastructure system 902, such as to request a service provided by cloud infrastructure system 902.

In some aspects, the processing performed by cloud infrastructure system 902 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 902 for determining the intent of an utterance. The data used for this analysis may include structured data (e.g., data stored in a database or structured according to a structured model) and/or unstructured data (e.g., data blobs (binary large objects)).

As depicted in the embodiment in FIG. 9, cloud infrastructure system 802 may include infrastructure resources 930 that are utilized for facilitating the provision of various cloud services offered by cloud infrastructure system 902. Infrastructure resources 930 may include, for example, processing resources, storage or memory resources, networking resources, and the like.

In certain aspects, to facilitate efficient provisioning of these resources for supporting the various cloud services provided by cloud infrastructure system 902 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 902 may itself internally use services 932 that are shared by different components of cloud infrastructure system 902 and which facilitate the provisioning of services by cloud infrastructure system 902. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 902 may comprise multiple subsystems. These subsystems may be implemented in software, or hardware, or combinations thereof. As depicted in FIG. 9, the subsystems may include a user interface subsystem 912 that enables users of cloud infrastructure system 902 to interact with cloud infrastructure system 902.

User interface subsystem 912 may include various different interfaces such as a web interface 914, an online store interface 916 where cloud services provided by cloud infrastructure system 902 are advertised and are purchasable by a consumer, and other interfaces 918. For example, a tenant may, using a client device, request (service request 934) one or more services provided by cloud infrastructure system 902 using one or more of interfaces 914, 916, and 918. For example, a tenant may access the online store, browse cloud services offered by cloud infrastructure system 902, and place a subscription order for one or more services offered by cloud infrastructure system 902 that the tenant wishes to subscribe to. The service request may include information identifying the tenant and one or more services that the tenant desires to subscribe to.

In certain aspects, such as the embodiment depicted in FIG. 9, cloud infrastructure system 902 may comprise an order management subsystem (OMS) 920 that is configured to process the new order. As part of this processing, OMS 920 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 920 may then invoke the order provisioning subsystem (OPS) 924 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 924 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 902 may send a response or notification 944 to the requesting tenant to indicate when the requested service is now ready for use. In some instances, information (e.g., a link) may be sent to the tenant that enables the tenant to start using and availing the benefits of the requested services.

Cloud infrastructure system 902 may provide services to multiple tenants. For each tenant, cloud infrastructure system 902 is responsible for managing information related to one or more subscription orders received from the tenant, maintaining tenant data related to the orders, and providing the requested services to the tenant or clients of the tenant. Cloud infrastructure system 902 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 902 may provide services to multiple tenants in parallel. Cloud infrastructure system 902 may store information for these tenants, including possibly proprietary information. In certain aspects, cloud infrastructure system 702 comprises an identity management subsystem (IMS) 928 that is configured to manage tenant's information and provide the separation of the managed information such that information related to one tenant is not accessible by another tenant. IMS 928 may be configured to provide various security-related services such as identity services, such as information access management, authentication and authorization services, services for managing tenant identities and roles and related capabilities, and the like.

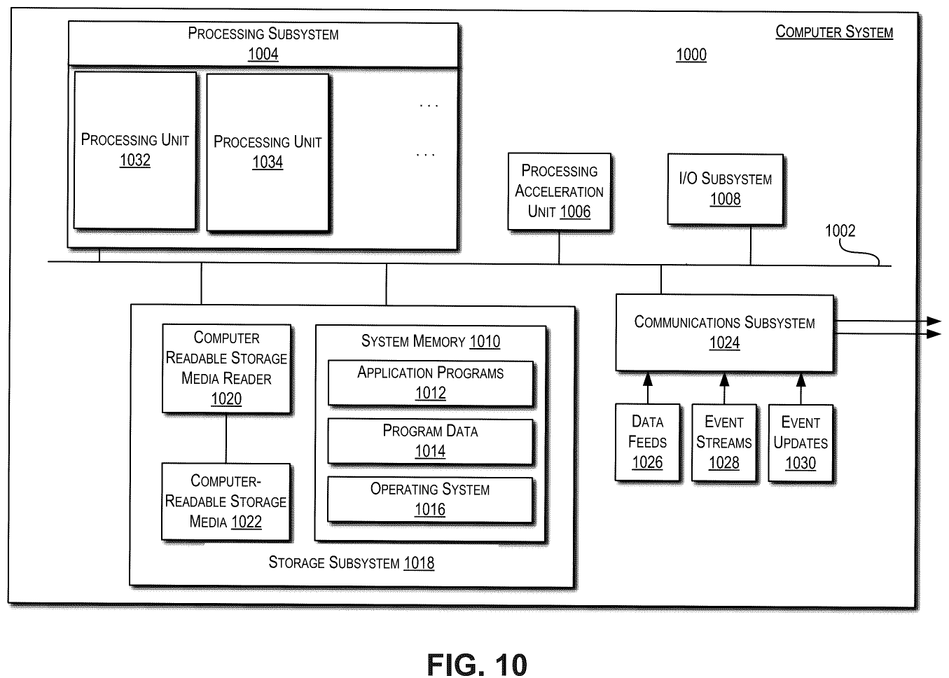

FIG. 10 illustrates an exemplary computer system 1000 that may be used to implement certain aspects. As shown in FIG. 10, computer system 1000 includes various subsystems including a processing subsystem 1004 that communicates with a number of other subsystems via a bus subsystem 1002. These other subsystems may include a processing acceleration unit 1006, an I/O subsystem 1008, a storage subsystem 1018, and a communications subsystem 1024. Storage subsystem 1018 may include non-transitory computer-readable storage media including storage media 1022 and a system memory 1010.

Bus subsystem 1002 provides a mechanism for letting the various components and subsystems of computer system 1000 communicate with each other as intended. Although bus subsystem 1002 is shown schematically as a single bus, alternative aspects of the bus subsystem may utilize multiple buses. Bus subsystem 1002 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 1004 controls the operation of computer system 1000 and may comprise one or more processors, application specific integrated circuits (ASICs), or field programmable gate arrays (FPGAs). The processors may include single core or multicore processors. The processing resources of computer system 1000 can be organized into one or more processing units 1032, 1034, etc. A processing unit may include one or more processors, one or more cores from the same or different processors, a combination of cores and processors, or other combinations of cores and processors. In some aspects, processing subsystem 1004 can include one or more special purpose co-processors such as graphics processors, digital signal processors (DSPs), or the like. In some aspects, some or all of the processing units of processing subsystem 1004 can be implemented using customized circuits, such as application specific integrated circuits (ASICs), or field programmable gate arrays (FPGAs).

In some aspects, the processing units in processing subsystem 1004 can execute instructions stored in system memory 1010 or on computer readable storage media 1022. In various aspects, the processing units can execute a variety of programs or code instructions and can maintain multiple concurrently executing programs or processes. At any given time, some or all of the program code to be executed can be resident in system memory 1010 and/or on computer-readable storage media 1022 including potentially on one or more storage devices. Through suitable programming, processing subsystem 1004 can provide various functionalities described above. In instances where computer system 1000 is executing one or more virtual machines, one or more processing units may be allocated to each virtual machine.

In certain aspects, a processing acceleration unit 806 may optionally be provided for performing customized processing or for off-loading some of the processing performed by processing subsystem 1004 so as to accelerate the overall processing performed by computer system 1000.

I/O subsystem 1008 may include devices and mechanisms for inputting information to computer system 1000 and/or for outputting information from or via computer system 1000. In general, use of the term input device is intended to include all possible types of devices and mechanisms for inputting information to computer system 1000. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 700 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 1018 provides a repository or data store for storing information and data that is used by computer system 1000. Storage subsystem 1018 provides a tangible non-transitory computer-readable storage medium for storing the basic programming and data constructs that provide the functionality of some aspects. Storage subsystem 1018 may store software (e.g., programs, code modules, instructions) that when executed by processing subsystem 1004 provides the functionality described above. The software may be executed by one or more processing units of processing subsystem 1004. Storage subsystem 1018 may also provide a repository for storing data used in accordance with the teachings of this disclosure.

Storage subsystem 1018 may include one or more non-transitory memory devices, including volatile and non-volatile memory devices. As shown in FIG. 10, storage subsystem 1018 includes a system memory 1010 and a computer-readable storage media 1022. System memory 1010 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 1000, such as during start-up, may typically be stored in the ROM. The RAM typically contains data and/or program modules that are presently being operated and executed by processing subsystem 1004. In some implementations, system memory 1010 may include multiple different types of memory, such as static random access memory (SRAM), dynamic random access memory (DRAM), and the like.

By way of example, and not limitation, as depicted in FIG. 10, system memory 1010 may load application programs 1012 that are being executed, which may include various applications such as Web browsers, mid-tier applications, relational database management systems (RDBMS), etc., program data 1014, and an operating system 1016. By way of example, operating system 1016 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 1022 may store programming and data constructs that provide the functionality of some aspects. Computer-readable media 1022 may provide storage of computer-readable instructions, data structures, program modules, and other data for computer system 1000. Software (programs, code modules, instructions) that, when executed by processing subsystem 1004 provides the functionality described above, may be stored in storage subsystem 1018. By way of example, computer-readable storage media 1022 may include non-volatile memory such as a hard disk drive, a magnetic disk drive, an optical disk drive such as a CD ROM, digital video disc (DVD), a Blu-Ray® disk, or other optical media. Computer-readable storage media 722 may include, but is not limited to, Zip® drives, flash memory cards, universal serial bus (USB) flash drives, secure digital (SD) cards, DVD disks, digital video tape, and the like. Computer-readable storage media 722 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 1018 may also include a computer-readable storage media reader 1020 that can further be connected to computer-readable storage media 1022. Reader 1020 may receive and be configured to read data from a memory device such as a disk, a flash drive, etc.

In certain aspects, computer system 1000 may support virtualization technologies, including but not limited to virtualization of processing and memory resources. For example, computer system 1000 may provide support for executing one or more virtual machines. In certain aspects, computer system 1000 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 1000. Accordingly, multiple operating systems may potentially be run concurrently by computer system 1000.

Communications subsystem 1024 provides an interface to other computer systems and networks. Communications subsystem 1024 serves as an interface for receiving data from and transmitting data to other systems from computer system 1000. For example, communications subsystem 924 may enable computer system 1000 to establish a communication channel to one or more client devices via the Internet for receiving and sending information from and to the client devices.

Communication subsystem 1024 may support both wired and/or wireless communication protocols. For example, in certain aspects, communications subsystem 1024 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 1024 can provide wired network connectivity (e.g., Ethernet) in addition to or instead of a wireless interface.

Communication subsystem 1024 can receive and transmit data in various forms. For example, in some aspects, in addition to other forms, communications subsystem 1024 may receive input communications in the form of structured and/or unstructured data feeds 1026, event streams 1028, event updates 1030, and the like. For example, communications subsystem 1024 may be configured to receive (or send) data feeds 1026 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 1024 may be configured to receive data in the form of continuous data streams, which may include event streams 1028 of real-time events and/or event updates 1030, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1024 may also be configured to communicate data from computer system 1000 to other computer systems or networks. The data may be communicated in various different forms such as structured and/or unstructured data feeds 1026, event streams 1028, event updates 1030, and the like to one or more databases that may be in communication with one or more streaming data source computers coupled to computer system 1000.

Computer system 1000 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 1000 depicted in FIG. 10 is intended only as a specific example. Many other configurations having more or fewer components than the system depicted in FIG. 10 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
causing display of at least part of a first table of data and at least part of a second table of data, wherein the at least part of the first table is displayed for matching against the second ledger;
for a first record of the first table, combining a first plurality of values of the first record, and generating a first vector embedding of the first plurality of values as combined;
for each set of one or more second records of a plurality of second records of the second table, combining a second plurality of values of the one or more second records into one or more combined sets of values, and generating one or more second vector embeddings of the one or more combined sets of values;
for each particular one or more second vector embeddings of a plurality of second vector embeddings generated from the generating the one or more second vector embeddings, determining a distance between the first vector embedding and the particular one or more second vector embeddings; wherein at least a first set of one or more second records has a closer distance than at least a second set of one or more second records;
wherein determining the distance uses a trained machine learning model that applies different weights for different component-level differences of a plurality of component-level differences from the first plurality of values;
based at least in part on determining the distance, graphically marking the first set of one or more second records with a higher confidence than the second set of one or more second records; and
causing display of an option to select the first set or the second set as a match for the first record, wherein using the option causes the selected set to be stored in association with the first record and causing generation of one or more reconciliation entries in association with one or more of the first table and the second table to account for a difference between the first record and the selected set.

2. The computer-implemented method of claim 1, wherein the one or more conditions check whether a value of the set of one or more second records when aggregated with zero or more other records of the set of one or more second records to be the same or within a threshold amount of a corresponding value of the first record.

3. The computer-implemented method of claim 2, wherein the corresponding value of the first record is a transaction amount.

4. The computer-implemented method of claim 1, wherein determining the distance comprises determining a cosine distance between the first vector embedding and the one or more second vector embeddings.

5. The computer-implemented method of claim 1, further comprising causing display of another option to select another of the first set or the second set as a non-match for the first record, wherein using the other option causes the other selected to be provided as negative feedback to the trained machine learning model, and wherein the trained machine learning model updates one or more of the weights based at least in part on the negative feedback.

6. The computer-implemented method of claim 1, further comprising, in response to using the option, providing the selected set and the first record as a labeled pair of positive feedback to the trained machine learning model; wherein using the option causes the trained machine learning model to update one or more of the weights based at least in part on the labeled pair of positive feedback for the selected set and the first record.

7. The computer-implemented method of claim 1, wherein determining a distance between the first vector embedding and the particular one or more second vector embeddings comprises determining a first distance between the first vector embedding and a third vector embedding and determining a second distance between the first vector embedding and a fourth vector embedding; and aggregating the first distance and the second distance to generate the distance.

8. The computer-implemented method of claim 1, wherein causing display of the option to select the first set or the second set as the match for the first record comprises displaying a dropdown menu in a user interface; wherein the dropdown menu comprises one or more options for selection of the first set or the second set.

9. The computer-implemented method of claim 1, wherein causing display of the option to select the first set or the second set as the match for the first record is performed in response to selection of the first record for matching, the computer-implemented method further comprising:
selecting a third record of the first table for an alternative matching process, and causing concurrent display of:
another option to perform the alternative matching process for the third record, and
content describing why the third record should be matched before the first record.

10. The computer-implemented method of claim 1, wherein causing display of the option to select the first set or the second set as the match for the first record is performed in response to selection of the first record for matching, the computer-implemented method further comprising:
automatically graphically marking a third record of the first table as a possible match for one or more sets of the one or more second records in response to the selection of the first record for matching.

11. The computer-implemented method of claim 1, wherein the trained machine learning model uses a random forest technique to randomly generate decision trees based on subsets of training data, use the decision trees to predict matches for the first record, and aggregating results of the decision trees to determine the higher confidence of the first set than the second set.

12. The computer-implemented method of claim 1, wherein the trained machine learning model uses a neural network with a plurality of layers; wherein a layer of the neural network reduces a number of candidate matches of the second table based on transaction amounts and another layer of the neural network outputs the higher confidence of the first set than the second set.

13. The computer-implemented method of claim 1, wherein the trained machine learning model uses a decision tree with a plurality of branches; wherein a branch of the decision tree reduces a number of candidate matches of the second table based on transaction amounts and another branch of the decision tree outputs a classification that contributes to the higher confidence of the first set than the second set.

14. The computer-implemented method of claim 1, wherein the trained machine learning model uses a naïve bayes algorithm to determine the higher confidence of the first set than the second set based on a historical probability of other sets of records being labeled as matches to records based on similar characteristics than were used between the first set and the first record.

15. The computer-implemented method of claim 1, wherein the trained machine learning model uses a generalized linear model to determine the higher confidence of the first set than the second set based on a historical distribution of sets of records matched to records based on characteristics similar to the first record.

16. A computer-program product comprising one or more non-transitory machine-readable storage media, including stored instructions configured to cause a computing system to perform a set of actions including:
causing display of at least part of a first table of data and at least part of a second table of data, wherein the at least part of the first table is displayed for matching against the second table;
for a first record of the first table, combining a first plurality of values of the first record, and generating a first vector embedding of the first plurality of values as combined;
for each set of one or more second records of a plurality of second records of the second table that satisfy one or more conditions, combining a second plurality of values of the one or more second records into one or more combined sets of values, and generating one or more second vector embeddings of the one or more combined sets of values;
for each particular one or more second vector embeddings of a plurality of second vector embeddings generated from the generating the one or more second vector embeddings, determining a distance between the first vector embedding and the particular one or more second vector embeddings; wherein at least a first set of one or more second records has a closer distance than at least a second set of one or more second records; wherein determining the distance uses a trained machine learning model that applies different weights for different component-level differences of a plurality of component-level differences from the first plurality of values;
based at least in part on determining the distance, graphically marking the first set of one or more second records with a higher confidence than the second set of one or more second records; and
causing display of an option to select the first set or the second set as a match for the first record, wherein using the option causes the selected set to be stored in association with the first record and causing generation of one or more reconciliation entries in association with one or more of the first table and the second table to account for a difference between the first record and the selected set.

17. The computer-program product of claim 16, wherein the set of actions further includes causing display of another option to select another of the first set or the second set as a non-match for the first record, wherein using the other option causes the other selected to be provided as negative feedback to the trained machine learning model, and wherein the trained machine learning model updates one or more of the weights based at least in part on the negative feedback.

18. The computer-program product of claim 16, wherein using the option causes the trained machine learning model to update one or more of the weights based at least in part on positive feedback for the selected set.

19. The computer-program product of claim 16, wherein determining a distance between the first vector embedding and the particular one or more second vector embeddings comprises determining a first distance between the first vector embedding and a third vector embedding and determining a second distance between the first vector embedding and a fourth vector embedding; and aggregating the first distance and the second distance to generate the distance.

20. The computer-program product of claim 16, wherein causing display of the option to select the first set or the second set as the match for the first record comprises displaying a dropdown menu in a user interface for selection of the first set or the second set.

21. The computer-program product of claim 16, wherein causing display of the option to select the first set or the second set as the match for the first record is performed in response to selection of the first record for matching; wherein the set of actions further comprises automatically graphically marking a third record of the first table as a possible match for one or more sets of the one or more second records in response to the selection of the first record for matching.

22. A system, comprising:
one or more processors;
one or more non-transitory computer-readable media storing instructions, which, when executed by the system, cause the system to perform a set of actions including:
causing display of at least part of a first table of data and at least part of a second table of data, wherein the at least part of the first table is displayed for matching against the second table;
for a first record of the first table, combining a first plurality of values of the first record, and generating a first vector embedding of the first plurality of values as combined;
for each set of one or more second records of a plurality of second records of the second table that satisfy one or more conditions, combining a second plurality of values of the one or more second records into one or more combined sets of values, and generating one or more second vector embeddings of the one or more combined sets of values;
for each particular one or more second vector embeddings of a plurality of second vector embeddings generated from the generating the one or more second vector embeddings, determining a distance between the first vector embedding and the particular one or more second vector embeddings; wherein at least a first set of one or more second records has a closer distance than at least a second set of one or more second records; wherein determining the distance uses a trained machine learning model that applies different weights for different component-level differences of a plurality of component-level differences from the first plurality of values;
based at least in part on determining the distance, graphically marking the first set of one or more second records with a higher confidence than the second set of one or more second records; and
causing display of an option to select the first set or the second set as a match for the first record, wherein using the option causes the selected set to be stored in association with the first record and causing generation of one or more reconciliation entries in association with one or more of the first table and the second table to account for a difference between the first record and the selected set.

23. The system of claim 22, wherein the set of actions further includes: causing display of another option to select another of the first set or the second set as a non-match for the first record, wherein using the other option causes the other selected to be provided as negative feedback to the trained machine learning model, and wherein the trained machine learning model updates one or more of the weights based at least in part on the negative feedback.

24. The system of claim 22, wherein using the option causes the trained machine learning model to update one or more of the weights based at least in part on positive feedback for the selected set.

25. The system of claim 22, wherein determining a distance between the first vector embedding and the particular one or more second vector embeddings comprises determining a first distance between the first vector embedding and a third vector embedding and determining a second distance between the first vector embedding and a fourth vector embedding; and aggregating the first distance and the second distance to generate the distance.
